(19) United States
(12) Patent Application Publication
(10) Pub. No.: US 2026/0025602 A1
(43) Pub. Date: Jan. 22, 2026

(54) PHOTOELECTRIC CONVERSION APPARATUS, IMAGING APPARATUS, AND EQUIPMENT

(71) Applicant: CANON KABUSHIKI KAISHA, Tokyo (JP)

(72) Inventors: SHINYA IGARASHI, Kanagawa (JP); KAZUNORI MATSUYAMA, Kanagawa (JP); HIDETOSHI HAYASHI, Kanagawa (JP); HIROTAKA SHUKURI, Tokyo (JP); NORIYUKI SHIKINA, Tokyo (JP)

(21) Appl. No.: 19/254,245

(22) Filed: Jun. 30, 2025

(30) Foreign Application Priority Data
Jul. 16, 2024 (JP) 2024-113699

(51) Int. Cl. H04N 25/78; H04N 25/704

(52) U.S. Cl. CPC H04N 25/78; H04N 25/704

(57) ABSTRACT

A photoelectric conversion apparatus includes a plurality of pixels, a plurality of output lines, a first A/D conversion circuit, a second A/D conversion circuit, a third A/D conversion circuit, and a switching unit configured to switch to which A/D conversion circuit the analog signal transmitted by each of the plurality of output lines is to be input. The switching unit is configured to input the analog signal transmitted through the first output line to the first A/D conversion circuit, input the analog signal transmitted through the second output line to the second A/D conversion circuit, and switch whether to input the analog signal transmitted by the third output line together with the analog signal transmitted by the first output line to the first A/D conversion circuit or to input the analog signal transmitted by the third output line to the third A/D conversion circuit.

### BACKGROUND

### Field of the Technology

The present technology relates to a photoelectric conversion apparatus including focus detection pixels for phase difference auto focus (AF), and the like.

### Description of the Related Art

In the field of an imaging apparatus including an imaging element such as a complementary metal oxide semiconductor (CMOS) image sensor, a method of detecting a phase difference on an imaging surface of the imaging element and performing autofocusing is known.

JP 2020-98968 A describes an imaging apparatus including a plurality of microlenses arranged in a matrix, a pair of photodiodes disposed corresponding to each microlens, and a pixel signal generation unit for phase difference AF detection.

In the imaging apparatus described in JP 2020-98968 A, an image is generated using signals of two frames with an odd number and an even number. In this method, focus detection is possible corresponding to each of the odd-numbered and even-numbered frames, but a frame rate of the generated image is ½ thereof. Therefore, there is a possibility that image quality as a moving image cannot be sufficiently high. In JP 2020-98968 A, a configuration suitable for adding pixel signals of three or more pixels arranged in a direction in which the phase difference is detected, a method of switching the number of pixels to be added, a method of reducing power consumption, and the like are not specifically studied. Therefore, there has been a demand for a photoelectric conversion apparatus capable of performing both generation of an image having a desired characteristic and focus detection at a high speed.

### SUMMARY

According to a first aspect of the present disclosure, a photoelectric conversion apparatus includes a pixel section in which a plurality of pixels is arranged along rows and columns, each of the plurality of pixels including a first photoelectric conversion unit, a second photoelectric conversion unit, a first transfer transistor, a second transfer transistor, a floating diffusion, and one microlens shared by the first photoelectric conversion unit and the second photoelectric conversion unit, an output line group including a plurality of output lines, each of the plurality of output lines transmitting an analog signal output from a corresponding one of the plurality of pixels arranged along the columns, an A/D conversion unit including a first A/D conversion circuit, a second A/D conversion circuit, and a third A/D conversion circuit, and a switching unit configured to switch to which A/D conversion circuit included in the A/D conversion unit the analog signal transmitted by each of the plurality of output lines is to be input. In each of the plurality of pixels, the second photoelectric conversion unit is disposed in the same direction with respect to the first photoelectric conversion unit, the first transfer transistor is included in a transfer path of a signal charge from the first photoelectric conversion unit to the floating diffusion, and the second transfer transistor is included in a transfer path of a signal charge from the second photoelectric conversion unit to the floating diffusion. One row of the pixel section includes a first pixel, a second pixel, and a third pixel. A first control line is connected to a gate of the first transfer transistor of the first pixel, a gate of the second transfer transistor of the second pixel, and a gate of the first transfer transistor of the third pixel. A second control line is connected to a gate of the second transfer transistor of the first pixel, a gate of the first transfer transistor of the second pixel, and a gate of the second transfer transistor of the third pixel. A first output line included in the output line group is connected to the first pixel. A second output line included in the output line group is connected to the second pixel. A third output line included in the output line group is connected to the third pixel. The switching unit is configured to input the analog signal transmitted through the first output line to the first A/D conversion circuit, input the analog signal transmitted through the second output line to the second A/D conversion circuit, and switch whether to input the analog signal transmitted by the third output line together with the analog signal transmitted by the first output line to the first A/D conversion circuit or to input the analog signal transmitted by the third output line to the third A/D conversion circuit. Power consumption of the third A/D conversion circuit is lower than both power consumption of the first A/D conversion circuit and power consumption of the second A/D conversion circuit in a period in which the switching unit inputs the analog signal transmitted through the third output line together with the analog signal transmitted by the first output line to the first A/D conversion circuit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for describing an overall configuration of an imaging apparatus according to an embodiment.

FIG. 2A is a circuit diagram illustrating a circuit configuration of a pixel unit.

FIG. 2B is a schematic plan view of the pixel unit in plan view.

FIG. 3 is a partial circuit diagram obtained by extracting a part of a photoelectric conversion apparatus according to a first embodiment.

FIG. 4 is a partial circuit diagram obtained by enlarging a part of FIG. 3.

FIG. 5 is a timing chart for describing a signal output procedure in an imaging method according to the first embodiment.

FIG. 6 is a schematic block diagram illustrating an example of a configuration of a signal processing unit.

FIG. 7 is a partial circuit diagram obtained by extracting a part of a photoelectric conversion apparatus according to a second embodiment.

FIG. 8 is a timing chart for describing a signal output procedure in an imaging method according to the second embodiment.

FIG. 9 is a timing chart for describing a signal output procedure in an imaging method according to a third embodiment.

FIG. 10A is a schematic diagram for describing equipment including the imaging apparatus (semiconductor apparatus) according to the embodiment.

FIG. 10B is a diagram illustrating an example of a photoelectric conversion system related to an in-vehicle camera.

FIG. 10C is a diagram illustrating the photoelectric conversion system in the case of imaging an area in front of a vehicle.

### DESCRIPTION OF THE EMBODIMENTS

Embodiments of the present technology will be described with reference to the drawings. The embodiments described below are merely examples, and for example, detailed configurations can be appropriately changed and implemented by those skilled in the art without departing from the gist of the present technology.

Note that, in the drawings referred to in the following embodiments and description, elements denoted by the same reference signs have similar functions unless otherwise specified. In the drawings, in a case where a plurality of the same elements are arranged, reference signs and a description thereof may be omitted.

In addition, the drawings may be schematic for convenience of illustration and description, and thus, the shape, size, arrangement, and the like of elements in the drawings may not strictly match those of actual ones. In the following description, directly viewing or seeing through a photoelectric conversion apparatus from a direction perpendicular to a main surface of a semiconductor layer may be referred to as plan view. In describing arrangement of pixels with reference to the drawings, “row” refers to arrangement in a horizontal direction, and “column” refers to arrangement in a vertical direction.

A conductivity type of a transistor described in the following embodiments is an example, and is not limited to only the conductivity type described in the embodiments. The conductivity type can be appropriately changed from the conductivity type described in the embodiments, and potentials of a gate, a source, and a drain of the transistor are appropriately changed with such a change. For example, in the case of a transistor that operates as a switch, it is sufficient if a low level and a high level of a control signal supplied to the gate is reversed with respect to the description in the embodiments along with the change of the conductivity type.

### First Embodiment

An imaging apparatus, a photoelectric conversion apparatus, and the like according to a first embodiment will be described with reference to the drawings. The imaging apparatus includes the photoelectric conversion apparatus and a signal processing unit. First, a schematic configuration of the imaging apparatus will be described, and then a configuration and a driving method of each unit will be described.

### Configuration of Imaging Apparatus

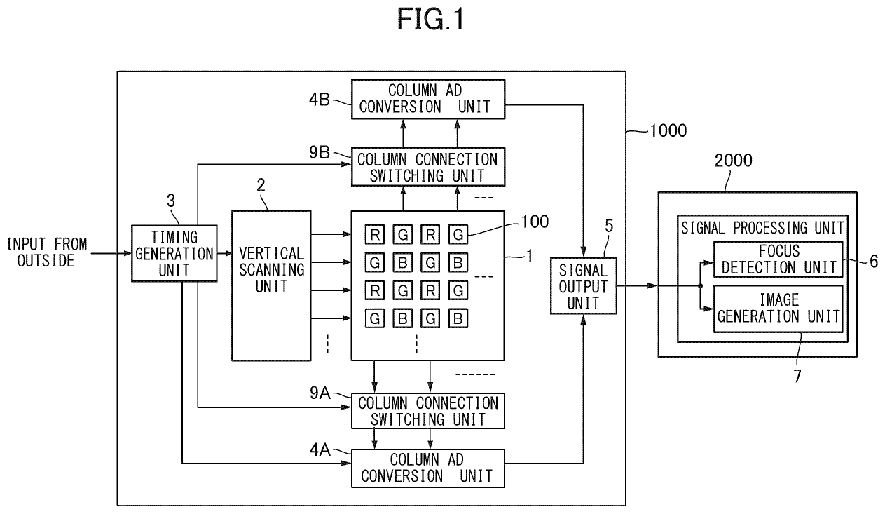

An overall configuration of the imaging apparatus according to the embodiment will be described with reference to FIG. 1. The imaging apparatus includes a photoelectric conversion apparatus 1000 and a signal processing unit 2000. The photoelectric conversion apparatus 1000 and the signal processing unit 2000 may be implemented by separate semiconductor substrates, or may be implemented by the same semiconductor substrate.

First, the photoelectric conversion apparatus 1000 will be described. The photoelectric conversion apparatus 1000 includes a pixel section 1, a vertical scanning unit 2, a timing generation unit 3, a column A/D conversion unit 4A, a column A/D conversion unit 4B, a signal output unit 5, a column connection switching unit 9A, and a column connection switching unit 9B.

The timing generation unit 3 controls the start and end of an operation of the imaging apparatus according to an input from the outside, and generates various timing signals for controlling an operation timing of each unit of the photoelectric conversion apparatus 1000. For example, various timing signals are output to the vertical scanning unit 2, the column A/D conversion unit 4A, the column A/D conversion unit 4B, the signal output unit 5, the column connection switching unit 9A, and the column connection switching unit 9B.

The pixel section 1 includes a pixel group in which a plurality of pixel units 100 having a photoelectric conversion function are two-dimensionally arranged along rows and columns. Any one of color filters of red, green, and blue is mounted on each pixel unit 100. In the illustrated example, red and green color filters are alternately arranged from a left end in an odd-numbered row of the pixel section 1, and green and blue color filters are alternately arranged in an even-numbered row to form a Bayer arrangement. However, a color type and arrangement method of the color filter can be appropriately changed according to an application of the imaging apparatus. For convenience of illustration, in the drawings, red is abbreviated as R, green is abbreviated as G, and blue is abbreviated as B.

The vertical scanning unit 2 supplies, to the pixel section 1, a drive signal for sequentially scanning the pixel units 100 arranged along the rows and the columns in the vertical direction while driving the pixel units 100 in units of rows.

The pixel units 100 arranged along the same column are connected to the same vertical output line (not illustrated in FIG. 1). A vertical output line connecting the pixel units 100 of the odd-numbered column is taken out to a lower side of FIG. 1 and connected to the column connection switching unit 9A. Further, a vertical output line connecting the pixel units 100 of the even-numbered column is taken out to an upper side of FIG. 1 and connected to the column connection switching unit 9B. An individual vertical output line may be referred to as an output line, a plurality of vertical output lines may be collectively referred to as an output line group, and the column connection switching unit 9A and the column connection switching unit 9B may be referred to as switching units. It can also be said that the output line group includes a plurality of output lines that transmit analog signals output from the pixel units arranged along the column.

The column connection switching unit 9A is connected to the column A/D conversion unit 4A, and the column connection switching unit 9B is connected to the column A/D conversion unit 4B. The column A/D conversion unit 4A includes the same number of A/D conversion circuits as the number of odd-numbered columns, and the column A/D conversion unit 4B includes the same number of A/D conversion circuits as the number of even-numbered columns.

The analog signal output from the pixel unit 100 of the odd-numbered column is input to the column connection switching unit 9A via the vertical signal line. The column connection switching unit 9A inputs the analog signal output from the pixel unit 100 of the odd-numbered column to an appropriate A/D conversion circuit included in the column A/D conversion unit 4A. The column connection switching unit 9A has a function of switching a connection relationship between the vertical output line and the A/D conversion circuit, which is described in detail below.

Similarly, the analog signal output from the pixel unit 100 of the even-numbered column is input to the column connection switching unit 9B via the vertical signal line. The column connection switching unit 9B inputs an output signal from the pixel unit 100 of the even-numbered column to an appropriate A/D conversion circuit included in the column A/D conversion unit 4B.

The analog signal output from the pixel unit 100 of the odd-numbered column is converted into a digital signal by the column A/D conversion unit 4A, and the analog signal output from the pixel unit 100 of the even-numbered column is converted into a digital signal by the column A/D conversion unit 4B. The digital signals for one row converted by the column A/D conversion unit are temporarily held in a memory, and the held digital signals are read by horizontal scanning and sequentially output to the signal output unit 5. The signal output unit 5 transfers the digital signal to the signal processing unit 2000 by a transmission method conforming to a protocol in a system.

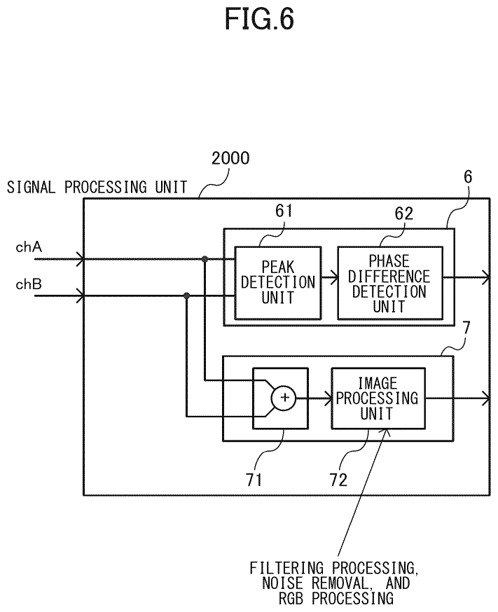

The signal processing unit 2000 includes a focus detection unit 6 that performs focus detection by phase difference detection using the digital signal transferred from the signal output unit 5, and an image generation unit 7 that generates an image by using the same digital signal. Details are described below with reference to FIG. 6.

### Configuration of Pixel Unit

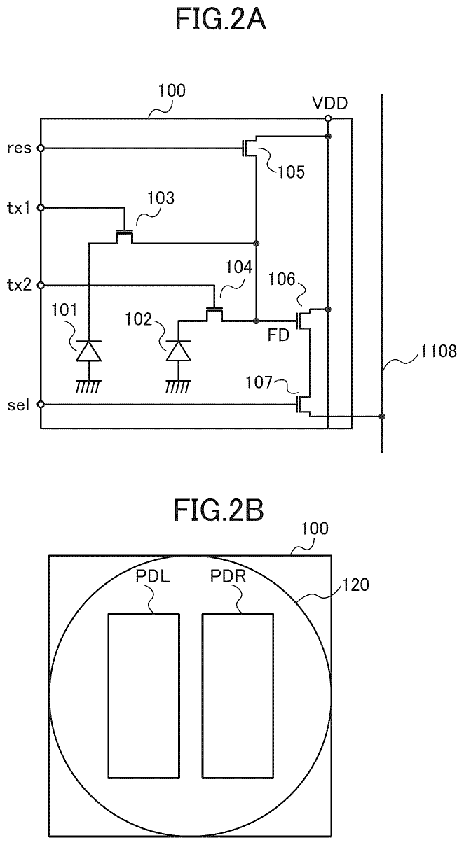

Next, the pixel unit 100 included in the pixel section 1 will be described. FIG. 2A is a circuit diagram illustrating a circuit configuration of the pixel unit 100.

The pixel unit 100 includes a photoelectric conversion unit 101, a photoelectric conversion unit 102, a transfer transistor 103, a transfer transistor 104, a reset transistor 105, a floating diffusion FD, an amplification transistor 106, and a selection transistor 107. The pixel unit 100 receives a transfer control signal tx1, a transfer control signal tx2, a reset control signal res, and a selection control signal sel from the vertical scanning unit 2 (FIG. 1).

Each transistor is a metal-oxide-semiconductor (MOS) transistor, and an appropriate conductivity type transistor can be used according to a polarity of a signal to be handled. The photoelectric conversion unit 101 and the photoelectric conversion unit 102 are photoelectric conversion elements (for example, photodiodes) that perform photoelectric conversion and generate charges according to an incident light quantity.

A signal charge photoelectrically converted by the photoelectric conversion unit 101 is transferred to the floating diffusion FD via the transfer transistor 103 driven by the transfer control signal tx1. A signal charge photoelectrically converted by the photoelectric conversion unit 102 is transferred to the floating diffusion FD via the transfer transistor 104 driven by the transfer control signal tx2. In other words, a first transfer transistor (transfer transistor 103) is included in a transfer path of the signal charge from a first photoelectric conversion unit (photoelectric conversion unit 101) to the floating diffusion. In addition, a second transfer transistor (transfer transistor 104) is included in a transfer path of the signal charge from a second photoelectric conversion unit (photoelectric conversion unit 102) to the floating diffusion.

The floating diffusion FD is a capacitor that holds the signal charge transferred from the photoelectric conversion unit, and a potential of the floating diffusion FD is amplified by the amplification transistor 106. That is, the amplification transistor 106 outputs a signal voltage corresponding to the signal charge.

An output signal of the amplification transistor 106 is output to a vertical output line 108 via the selection transistor 107 driven by the selection control signal sel. The signal charge (or the potential of the floating diffusion FD) held in the floating diffusion FD is reset via the reset transistor 105 driven by the reset control signal res.

In the pixel unit 100 according to the present embodiment, the floating diffusion FD shared by the photoelectric conversion unit 101 and the photoelectric conversion unit 102 is provided. Therefore, by simultaneously turning on the transfer transistor 103 and the transfer transistor 104, the signal charges generated in both the photoelectric conversion unit 101 and the photoelectric conversion unit 102 can be transferred to the floating diffusion FD. In this case, a signal voltage obtained by adding (or averaging) outputs of the photoelectric conversion unit 101 and the photoelectric conversion unit 102 is output from the amplification transistor 106.

On the other hand, by turning on only one of the transfer transistor 103 and the transfer transistor 104, the signal charge generated in the photoelectric conversion unit 101 or the photoelectric conversion unit 102 can be transferred to the floating diffusion FD. In this case, for example, a signal voltage that can be used to generate a phase difference signal for focus detection is output from the amplification transistor 106.

Next, a layout of the photoelectric conversion unit in the pixel unit 100 will be described. FIG. 2B is a schematic plan view of the pixel unit 100 in plan view. A photoelectric conversion unit PDL and a photoelectric conversion unit PDR share a microlens 120, the photoelectric conversion unit PDL is disposed on a left side of an optical center of the microlens 120, and the photoelectric conversion unit PDR is disposed on a right side of the optical center of the microlens 120. That is, the photoelectric conversion unit PDL and the photoelectric conversion unit PDR are disposed so as to receive light passing through different regions of a pupil of an optical system. Consequently, phase difference detection can be performed by acquiring different parallax signals on the left and right sides using the two photoelectric conversion units.

Although a configuration in which the two photoelectric conversion units are disposed on the left and right in the microlens has been exemplified here, a disposition method therefor is not limited thereto, and for example, the photoelectric conversion units may be disposed on upper and lower sides. In addition, for example, four photoelectric conversion units sharing one microlens may be disposed in one pixel unit.

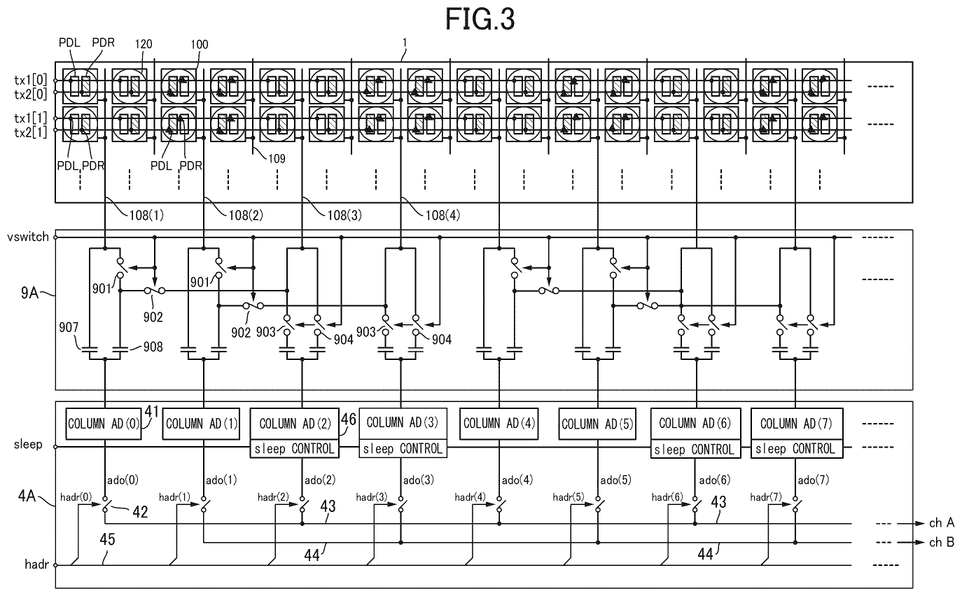

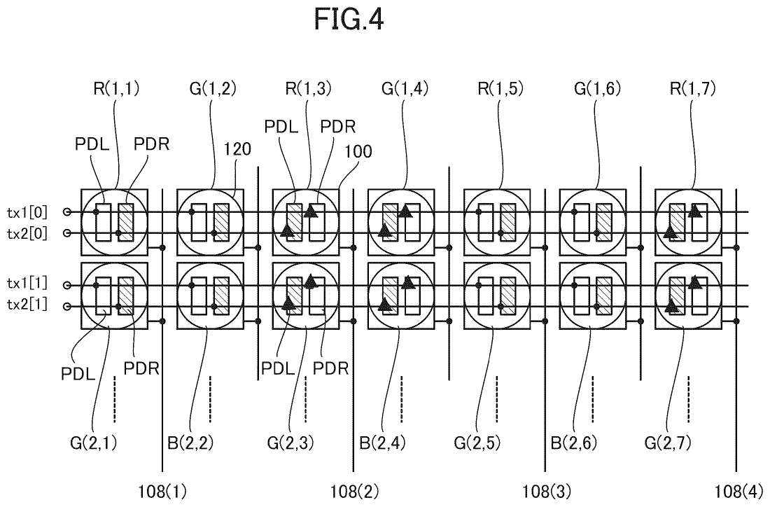

In FIG. 2A, the photodiode connected to the transfer transistor 103 driven by the transfer control signal tx1 is the photoelectric conversion unit 101, and the photodiode connected to the transfer transistor 104 driven by the transfer control signal tx2 is the photoelectric conversion unit 102. As described below with reference to FIGS. 3 and 4, the photoelectric conversion unit PDL may correspond to the photoelectric conversion unit 101 or may correspond to the photoelectric conversion unit 102 on the circuit diagram depending on a column in which the pixel unit is disposed. Similarly, the photoelectric conversion unit PDR may correspond to the photoelectric conversion unit 102 or may correspond to the photoelectric conversion unit 101 on the circuit diagram depending on a column in which the pixel unit is disposed.

Next, the column connection switching unit and the column A/D conversion unit included in the photoelectric conversion apparatus 1000 will be described. FIG. 3 is a partial circuit diagram obtained by extracting parts of the pixel section 1 and the column connection switching unit 9A and the column A/D conversion unit 4A that handle a signal of the odd-numbered column, the pixel section 1 and the column connection switching unit 9A and the column A/D conversion unit 4A being included in the photoelectric conversion apparatus 1000. A circuit configuration similar to that illustrated in FIG. 3 is repeatedly arranged in a portion (not illustrated) on the right side in the column connection switching unit 9A and the column A/D conversion unit 4A.

Furthermore, a signal output from the pixel unit 100 of the even-numbered column of the pixel section 1 is handled by the column connection switching unit 9B and the column A/D conversion unit 4B illustrated on the upper side of FIG. 1, and is handled in the same manner as a signal output from the pixel unit 100 of the odd-numbered column described below.

FIG. 3 illustrates a portion in which two pixel units 100 are arranged in the vertical direction (column direction) and 16 pixel units 100 are arranged in the horizontal direction (row direction) in the pixel section 1. Furthermore, FIG. 4 that is an enlarged view of a part of FIG. 3 illustrates a portion in which two pixel units 100 are arranged in the vertical direction (column direction) and 7 pixel units 100 are arranged in the horizontal direction (row direction) in the pixel section 1. In FIG. 4, reference signs such as color filter colors (a row number and a column number) are illustrated for the individual pixel units. For example, a pixel unit on an upper-left side in the drawing is denoted by Reference Numeral R(1,1), which indicates that the pixel unit 100 disposed in the first row and the first column is a red pixel unit.

As illustrated in FIG. 1, the vertical output line connecting the pixel units 100 of the odd-numbered column is connected to the column connection switching unit 9A, and the vertical output line connecting the pixel units 100 of the even-numbered column is connected to the column connection switching unit 9B.

In FIGS. 3 and 4, the vertical output line 108 taken out to the lower side is illustrated, and, for example, the vertical output line connecting the pixel units of the first column is denoted as a vertical output line 108(1). Similarly, the vertical output lines connecting the pixel units of the third, fifth, and seventh columns are denoted as a vertical output line 108(2), a vertical output line 108(3), a and vertical output line 108(4), respectively.

In FIGS. 3 and 4, the transfer control signal tx1 and the transfer control signal tx2 supplied to the pixel units 100 of the first row are illustrated as a transfer control signal tx1[0] and a transfer control signal tx2[0], respectively. In addition, the transfer control signal tx1 and the transfer control signal tx2 supplied to the pixel units 100 of the second row are illustrated as a transfer control signal tx1[1] and a transfer control signal tx2[1]. A wiring for transmitting the transfer control signal tx1 to a gate of the transfer transistor 103 of each pixel unit in each row may be referred to as a first control line, and a wiring for transmitting the transfer control signal tx2 to a gate of the transfer transistor 104 of each pixel unit in each row may be referred to as a second control line.

As described below, analog signals are simultaneously read from all the pixel units arranged in one row from the pixel section 1 (FIG. 1) and are handled by the column connection switching unit 9A and the column connection switching unit 9B. The column connection switching unit 9A that handles the analog signal of the vertical output line of the odd-numbered column handles the analog signals output from the pixel units of the same color arranged in the row being read. As can be seen from FIG. 4, for example, the pixel units of the odd-numbered columns in the first row are pixels units of the same color, the red pixel units, and the pixel units of the odd-numbered columns in the second row are pixel units of the same color, the green pixel units. Therefore, the analog signals handled by the column connection switching unit 9A and the column A/D conversion unit 4A for the pixel units of the first row are signals of the same color, red signals, and the analog signals handled for the pixel units of the second row are signals of the same color, green signals. Similarly, the column connection switching unit 9B that handles the analog signal of the vertical output line of the even-numbered column also handles the analog signals output from the pixel units of the same color arranged in the row being read. For example, the pixel units of the even-numbered columns in the first row are the pixel units of the same color, the green pixel units, and the pixel units of the even-numbered columns in the second row are the pixel units of the same color, the blue pixel units. Therefore, the analog signals handled by the column connection switching unit 9B and the column A/D conversion unit 4B for the pixel units of the first row are signals of the same color, the green signals, and the analog signals handled for the pixel units of the second row are signals of the same color, the blue signals.

Next, a relationship between the photoelectric conversion unit PDL and the photoelectric conversion unit PDR disposed in each of the pixel units 100 and the transfer control signal supplied to the transfer transistor connected to the photoelectric conversion unit will be described. In FIG. 4, intersection points between the photoelectric conversion unit PDL and the photoelectric conversion unit PDR of each pixel unit and the transfer control signals tx1[0] to tx2[1] are schematically indicated by black circles or black triangles. That is, intersection points between the photoelectric conversion units and the transfer control signals are indicated by black circles in the pixel units of the first, second, fifth, and sixth columns, and intersection points between the photoelectric conversion units and the transfer control signals are indicated by black triangles in the pixel units of the third, fourth, and seventh columns. That is, the black circles and black triangles are alternately arranged every two columns.

The pixel unit whose intersection points are indicated by the black circles indicates that the signal charge is transferred from the photoelectric conversion unit PDL disposed on the left side in the microlens to the floating diffusion by the transfer transistor 103 driven by the transfer control signal tx1. In addition, the pixel unit whose intersection points are indicated by the black circles indicates that the signal charge is transferred from the photoelectric conversion unit PDR disposed on the right side in the microlens to the floating diffusion by the transfer transistor 104 driven by the transfer control signal tx2.

On the other hand, the pixel unit whose intersection points are indicated by the black triangles indicates that the signal charge is transferred from the photoelectric conversion unit PDR disposed on the right side in the microlens to the floating diffusion by the transfer transistor 103 driven by the transfer control signal tx1. In addition, the pixel unit whose intersection points are indicated by the black triangles indicates that the signal charge is transferred from the photoelectric conversion unit PDL disposed on the left side in the microlens to the floating diffusion by the transfer transistor 104 driven by the transfer control signal tx2.

### Column Connection Switching Unit

Returning to FIG. 3, the column connection switching unit 9A will be described. The column connection switching unit 9A has a function of switching a connection relationship between the vertical output line 108 connected to the pixel unit of the odd-numbered column and the A/D conversion circuit included in the column A/D conversion unit 4A. The column A/D conversion unit 4A includes column A/D (0) to column A/D (7) as A/D conversion circuits 41 corresponding to the respective columns. In other words, the column connection switching unit 9A (switching unit) can switch an A/D conversion circuit included in the column A/D conversion unit 4A (A/D conversion unit) to which the analog signal transmitted by the vertical output line 108(output line) is to be input.

The column connection switching unit 9A includes switches 901 to 904 for switching output destinations of the analog signals transmitted by the vertical output line 108, and capacitors 907 and 908 capable of holding the signals read from the vertical output line 108. The column connection switching unit 9A includes the capacitor 907 and the capacitor 908 connected in parallel corresponding to each column of the pixel unit, and the capacitors 907 and 908 are connected to input terminals of column A/D (0) to column A/D (7).

A connection control signal vswitch is input from the timing generation unit 3 (FIG. 1) to the column connection switching unit 9A, and opening and closing of the switches 901 to 904 are controlled by the connection control signal vswitch. FIG. 3 illustrates a case where the connection control signal vswitch is on (high). In this case, only the switch 902 is turned on, and the switch 901, the switch 903, and the switch 904 are turned off. When the connection control signal vswitch is off (low), opening and closing of each switch are reversed. Such a configuration of the switch can be implemented, for example, by using an N-type MOS transistor as the switch 902 and using P-type MOS transistors as the switch 901, the switch 903, and the switch 904. In addition, in a case where polarities of the switches 901 to 904 are all the same as each other, an inverter that outputs a signal obtained by inverting the connection control signal vswitch can be provided in each of input nodes of the switch 901, the switch 903, and the switch 904.

In each column of the column connection switching unit 9A, the capacitor 907 and the capacitor 908 are arranged in parallel. For example, in the leftmost column, the capacitor 907 is connected to the vertical output line 108(1), and the switch 901 is disposed between the capacitor 908 and the vertical output line 108(1). In addition, the switch 902 is disposed between the capacitor 908 in the leftmost column and the vertical output line 108(3). The switch 901 and the switch 902 perform an opening/closing operation exclusively by the connection control signal vswitch. Therefore, when the connection control signal vswitch is turned on, the vertical output line 108(3) is connected to the capacitor 908 in the leftmost column, and when the connection control signal vswitch is turned off, the vertical output line 108(1) is connected thereto. That is, in the leftmost column, when the connection control signal vswitch is turned on, the capacitor 907 is connected to the vertical output line 108(1), and the capacitor 908 is connected to the vertical output line 108(3). When the connection control signal vswitch is turned off, both the capacitor 907 and the capacitor 908 are connected to the vertical output line 108(1).

In the second column from the left in the column connection switching unit 9A, the capacitor 907 is connected to the vertical output line 108(2), and the switch 901 is disposed between the capacitor 908 and the vertical output line 108(2). In addition, the switch 902 is disposed between the capacitor 908 of the second column and the vertical output line 108(4). The switch 901 and the switch 902 perform an opening/closing operation exclusively by the connection control signal vswitch. Therefore, when the connection control signal vswitch is turned on, the vertical output line 108(4) is connected to the capacitor 908 of the second column, and when the connection control signal vswitch is turned off, the vertical output line 108(2) is connected thereto. That is, in the second column, when the connection control signal vswitch is turned on, the capacitor 907 is connected to the vertical output line 108(2), and the capacitor 908 is connected to the vertical output line 108(4). When the connection control signal vswitch is turned off, both the capacitor 907 and the capacitor 908 are connected to the vertical output line 108(2).

In the third column from the left in the column connection switching unit 9A, the switch 903 is disposed between the capacitor 907 and the vertical output line 108(3), and the switch 904 is disposed between the capacitor 908 and the vertical output line 108(3). When the connection control signal vswitch is turned on, the switch 903 and the switch 904 are turned off as illustrated in FIG. 3, and thus, no signal is input to the capacitor 907 and the capacitor 908 from the vertical output line 108(3). When the connection control signal vswitch is turned off, the switch 903 and the switch 904 are turned on, and thus, an analog voltage signal is input from the vertical output line 108(3) to the capacitor 907 and the capacitor 908.

Similarly, in the fourth column from the left in the column connection switching unit 9A, the switch 903 is disposed between the capacitor 907 and the vertical output line 108(4), and the switch 904 is disposed between the capacitor 908 and the vertical output line 108(4). When the connection control signal vswitch is turned on, the switch 903 and the switch 904 are turned off as illustrated in FIG. 3, and thus, no signal is input to the capacitor 907 and the capacitor 908 from the vertical output line 108(4). When the connection control signal vswitch is turned off, the switch 903 and the switch 904 are turned on, and thus, a signal is input to the capacitor 907 and the capacitor 908 from the vertical output line 108(4).

For example, a case where a signal transferred from the photoelectric conversion unit 101 (FIG. 2A) to the floating diffusion FD by the transfer control signal tx1[0] is read from the vertical output line 108 in a pixel unit group of the first row will be considered. As in the case illustrated in FIG. 3, it is assumed that the connection control signal vswitch is turned on.

In the pixel unit R(1,1) connected to the vertical output line 108(1) and the pixel unit R(1,5) connected to the vertical output line 108(3), a signal transferred from the left photoelectric conversion unit PDL (FIG. 4) is read by the transfer control signal tx1[0]. Therefore, an output signal based on the left photoelectric conversion unit PDL of the pixel unit R(1,1) is held in the capacitor 907, and an output signal based on the left photoelectric conversion unit PDL of the pixel unit R(1,5) is held in the capacitor 908 in the leftmost column.

As described above, in the leftmost column in the column connection switching unit 9A, analog signal voltages based on the signals of the left photoelectric conversion units PDL of the two pixel units of the same color are added by capacitive coupling and input to A/D (0) of the column A/D conversion unit 4A. Note that a voltage output from the capacitive coupling in parallel connection is not an addition value but an average value of the output signals of the two pixels. In the following description, for the sake of convenience, outputting from the capacitive coupling in parallel connection will be described as addition instead of averaging.

At this time, in the pixel unit R(1,3) connected to the vertical output line 108(2) and the pixel unit R(1,7) connected to the vertical output line 108(4), an analog signal based on the signal charge transferred from the right photoelectric conversion unit PDR(FIG. 4) is read by the transfer control signal tx1[0]. Therefore, an output signal based on the right photoelectric conversion unit PDR of the pixel unit R(1,3) is held in the capacitor 907, and an output signal based on the right photoelectric conversion unit PDR of the pixel unit R(1,7) is held in the capacitor 908 in the second column from the left in the column connection switching unit 9A.

As described above, in the second column from the left in the column connection switching unit 9A, analog signal voltages based on the signals of the right photoelectric conversion units PDR of the two pixels of the same color are added by capacitive coupling and input to A/D (1) of the column A/D conversion unit 4A.

At this time, in the third and fourth columns from the left in the column connection switching unit 9A, when the connection control signal vswitch is turned on, the switches 903 and 904 are turned off, and thus, no signal is input from the vertical output line to the capacitors 907 and 908. Therefore, the analog signals read from the pixel units are not input to A/D (2) and A/D (3) of the column A/D conversion unit 4A.

As described above, when the connection control signal vswitch is on, in the first column and the second column from the left in the column connection switching unit 9A, the vertical output lines that transmit the analog signals based on the photoelectric conversion units including the color filters of the same color and disposed on the same side in the pixel units are connected via the switch 902. In other words, the analog signal voltages of the pixel units that include the color filters of the same color and read the signal charges transferred from the photoelectric conversion units using the same transfer control signal tx are added (averaged) by capacitive coupling and input to the A/D conversion circuit.

When the connection control signal vswitch is on, in the third and fourth columns from the left in the column connection switching unit 9A, no signal is input from the vertical output line to the capacitors 907 and 908, and no analog signal read from the pixel unit is input to the corresponding A/D conversion circuit.

On the other hand, when the connection control signal vswitch is off, in all the columns in the column connection switching unit 9A, the analog signals are transmitted from the vertical output line corresponding to the column to the capacitor 907 and the capacitor 908 of the column. In other words, the analog signals output from the pixel units of different columns are not added, and the analog signal voltage is input to the A/D conversion circuit disposed corresponding to each column for each column of the pixel units.

### A/D Conversion Unit

Next, the A/D conversion unit 4A will be described. The A/D conversion unit 4A includes, corresponding to the respective columns of the column connection switching unit 9A, A/D (0), A/D (1), A/D (2) and the like serving as the A/D conversion circuits that convert an analog signal into a digital signal. A type of the A/D conversion circuit is not particularly limited, and for example, a comparator (not illustrated) is provided, and the analog signal output from the column connection switching unit 9A is compared with a ramp waveform (reference signal) from the outside. A time measurement counter (not illustrated) is used to measure a timing at which a comparator output is inverted, and a counter value at the inversion timing is held. As a result, A/D conversion is performed, and the counter value is held and output as a digital signal.

The A/D conversion circuit (for example, A/D (2) and A/D (3)) connected to a column in which the switches 903 and 904 are disposed in the column connection switching unit 9A is provided with a sleep control unit 46. The sleep control unit 46 can suppress power consumption by stopping an operation of the A/D conversion circuit. The sleep control unit 46 is operated based on a stop control signal sleep input from the timing generation unit 3 (FIG. 1), and the stop control signal sleep is turned on in synchronization with the turning on of the connection control signal vswitch input to the column connection switching unit 9A. When the connection control signal vswitch is on (that is, the stop control signal sleep is on), the operation of the A/D conversion circuit (for example, A/D (2) and A/D (3)) to which no output signal of the pixel unit is input is stopped to suppress the power consumption. In a case where an amplifier (column amplifier) for amplifying the analog signal is disposed upstream of the A/D conversion circuit, when the stop control signal sleep is on, power supply to the corresponding column amplifier may be stopped to suppress the power consumption. When the stop control signal sleep is on, the power supply to the A/D conversion circuit to which no output signal of the pixel unit is input does not have to be completely stopped. For example, when the stop control signal sleep is on, power may be supplied to the A/D conversion circuit to which no output signal of the pixel unit is input in a range of 0.1% or more and 30% or less of that in a normal operation of the A/D conversion circuit. Similarly, in a case where an amplifier (column amplifier) for amplifying the analog signal is disposed upstream of the A/D conversion circuit, the power supply to the amplifier does not have to be completely stopped, and the power may be supplied in a range of 0.1% or more and 30% or less of that in the normal operation.

On the other hand, when the connection control signal vswitch is off (that is, the stop control signal sleep is off), the output signal of the pixel unit of each column is input to the A/D conversion circuit of the corresponding column, and thus, all the A/D conversion circuits are operated.

A/D (0), A/D (1), A/D (2), and the like serving as the A/D conversion circuits are connected to ado (0), ado (1), ado (2), and the like serving as digital signal lines that transmit digital signals.

The A/D conversion unit 4A includes a horizontal transfer line 43 and a horizontal transfer line 44 for sequentially transferring the digital signals output from the A/D conversion circuits, and the horizontal transfer line 43 and the horizontal transfer line 44 are connected to the signal output unit 5 (FIG. 1). The A/D conversion circuits disposed in the odd-numbered columns in the A/D conversion unit 4A, that is, A/D (0), A/D (2), A/D (4), and the like, are connected to the horizontal transfer line 43 via a switch 42. The A/D conversion circuits disposed in the even-numbered columns, that is, A/D (1), A/D (3), A/D (5), and the like, are connected to the horizontal transfer line 44 via the switch 42. A horizontal transfer control signal hadr is input from the timing generation unit 3 (FIG. 1) to the switch 42 of each column.

When the connection control signal vswitch is on, the horizontal transfer control signal hadr is input such that the switch 42 connected to the A/D conversion circuit stopped by the sleep control unit 46 is skipped and horizontal scanning is performed. That is, the digital signals are output from the A/D conversion circuits in the order of A/D (0), A/D (4), and the like to the horizontal transfer line 43, and the digital signals are output from the A/D conversion circuits in the order of A/D (1), A/D (5), and the like to the horizontal transfer line 44.

When the connection control signal vswitch is off, the horizontal transfer control signal hadr is input so as to sequentially perform horizontal scanning of the switches 42 of respective columns. That is, the digital signals are output from the A/D conversion circuits in the order of A/D (0), A/D (2), A/D (4), and the like to the horizontal transfer line 43, and the digital signals are output from the A/D conversion circuits in the order of A/D (1), A/D (3), A/D (5), and the like to the horizontal transfer line 44.

### Signal Output Procedure

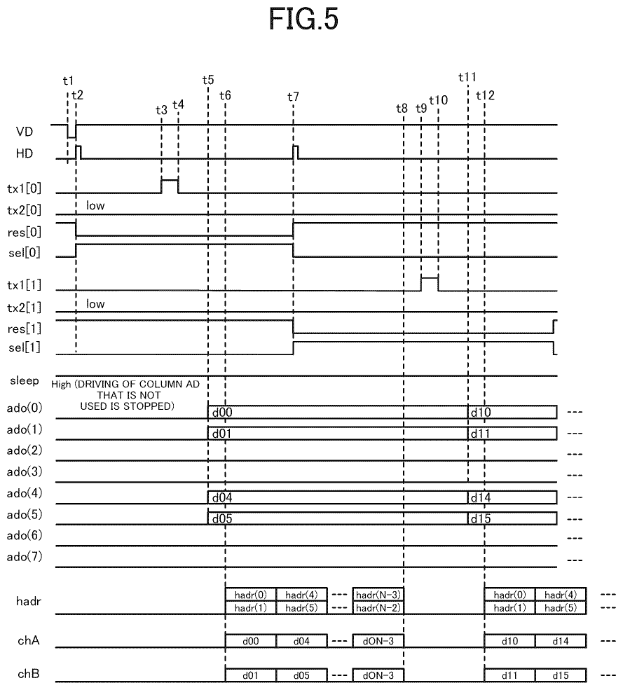

FIG. 5 is a timing chart for describing a signal output procedure in an imaging method according to the first embodiment. Similarly to FIG. 3, FIG. 5 illustrates a procedure in a case where the connection control signal vswitch is turned on (high), and the analog signals read from the photoelectric conversion units of the same color are added by the column connection switching unit 9A and are digitized and read by the column A/D conversion unit 4A. In FIGS. 3 and 4, among the photoelectric conversion units included in each pixel unit, the photoelectric conversion unit that is not read by an operation in a time chart illustrated in FIG. 5 is indicated by hatching.

First, at time t1, a vertical synchronization signal VD becomes low, and acquisition of one frame image is started. At time t2, a horizontal synchronization signal HD is input, and a read operation (in this case, the read operation for the first row) in one horizontal scanning period is started. The reset transistor 105 of the pixel unit of the first row is turned off because a reset control signal res[0] is low, and the selection transistor 107 of the pixel unit of the first row is turned on because a selection control signal sel[0] is high.

Next, in a period from time t3 to time t4, tx1[0] becomes high, but tx2[0] remains low. As described in the description of FIG. 3,[0] means a row address of the first row, and the same transfer control signal is supplied to all the pixel units of the first row.

As described for the column connection switching unit 9A, when the connection control signal vswitch is on, an addition value of the analog signals of the pixel unit R(1,1) and the pixel unit R(1,5) in which the signal charges have been transferred from the photoelectric conversion units PDL disposed on the left side is input to A/D (0). Further, an addition value of the analog signals of the pixel unit R(1,3) and the pixel unit R(1,7) in which the signal charges have been transferred from the photoelectric conversion units PDR disposed on the right side is input to the adjacent A/D (1).

In addition, when the connection control signal vswitch is on, the stop control signal sleep is also on, and thus, the operations of A/D (2) and A/D (3) are stopped by the sleep control unit 46, and the power consumption is reduced.

Subsequently, at time t5, an A/D conversion result is fixed in the operating A/D conversion circuit, the digital signal is held, and the digital signal is output to the digital signal line. That is, a digital signal d00 is output from A/D (0) to ado (0), and a digital signal d01 is output from A/D (1) to ado (1). On the other hand, no digital signal is output to ado (2) and ado (3) from A/D (2) and A/D (3) that have stopped operating.

Subsequently, at time t6, the switch 42 of each column is appropriately driven by the horizontal transfer control signal hadr, and horizontal transfer is performed. First, in the first transfer period, hadr(0) and hadr(1) are simultaneously turned on, and in the next transfer period, hadr(2) and hadr(3) are skipped, and hadr(4) and hadr(5) are simultaneously turned on. Thereafter, the horizontal transfer is sequentially performed for the first row. As a result, the digital signals obtained by adding the outputs of the left photoelectric conversion units of two pixels of the same color are sequentially read to the horizontal transfer line 43, and the digital signals obtained by adding the outputs of the right photoelectric conversion units of the two pixels of the same color are sequentially read to the horizontal transfer line 44. In other words, only an addition signal from the PDLs disposed on the left side in the pixel units 100 is output from the horizontal transfer line 43 to chA (channel A), and only an addition signal from the PDRs disposed on the right side in the pixel units 100 is output to chB (channel B).

Next, at time t7, the next horizontal synchronization signal HD is input, and the read operation in the next one horizontal scanning period (second row) is started. In the pixel unit of the first row in which the reading is completed, the selection control signal sel[0] becomes low, and thus, the selection transistor 107 is turned off. Further, in the pixel unit of the first row, the reset control signal res[0] becomes high, and thus, the reset transistor 105 is turned on, the floating diffusion FD is connected to a power supply, and the potential is reset. At the same time, the reset transistor 105 of the pixel unit of the second row is turned off because the reset control signal res[1] becomes low, and the selection transistor 107 of the pixel unit of the second row is turned on because the selection control signal sel[1] becomes high. Thereafter, the same operation as the read operation from time t2 in the first row is performed on the second row.

At time t7, the reading of the first row to the horizontal transfer line 43 and the horizontal transfer line 44 from time t6 does not have to be completed. Since the A/D conversion circuit of each column holds the A/D conversion result of the previous row, it is possible to perform horizontal transfer of the A/D conversion result (digital signal) of the previous row in parallel with the reading of the analog signal from the pixel unit of the next row.

At time t8, the reading of the digital signal of the first row to the horizontal transfer lines 43 and 44 started from time t6 is completed. During a period from time t8 at which the horizontal transfer of the digital signal of the first row is completed to time t12 at which the horizontal transfer of the digital signal of the second row is started, operation of the horizontal transfer control signal hadr and the switch 42 may be stopped. Time t7, at which the reading of the analog signal from the pixel unit of the second row is started, and time t8, at which the reading of the digital signal of the first row is completed, may occur in reverse order from that illustrated in FIG. 5.

Next, in a period from time t9 to time t10, tx1[1] becomes high, but tx2[1] remains low. As described in the description of FIG. 3,[1] means a row address indicating the second row, and the same transfer control signal is supplied to all the pixel units of the second row. In other words, the vertical scanning unit 2 (FIG. 1) advances row scanning in the vertical direction by one row.

At time t11, similarly to time t5 in the reading of the first row, the A/D conversion result is fixed in the operating A/D conversion circuit, the digital signal is held, and the digital signal is output to the digital signal line. That is, a digital signal d10 is output from A/D (0) to ado (0), and a digital signal d11 is output from A/D (1) to ado (1). On the other hand, no digital signal is output to ado (2) and ado (3) from A/D (2) and A/D (3) that have stopped operating. At time t12, similarly to time t6 in the reading of the first row, the switch 42 of each column is appropriately driven by the horizontal transfer control signal hadr, and the horizontal transfer is performed.

In this way, each time the horizontal synchronization signal HD is input, reading in units of rows is repeatedly performed while performing row scanning in the vertical direction, and the read operation of all the pixels (one frame) is completed.

As described above, the digital signal read from the photoelectric conversion apparatus 1000 illustrated in FIG. 1 is input to the signal processing unit 2000 and processed. In the photoelectric conversion apparatus 1000 (FIG. 1), the digital signals corresponding to the pixel units 100 of the odd-numbered columns are sequentially output from the column A/D conversion unit 4A, and the digital signals corresponding to the pixel units 100 of the even-numbered columns are sequentially output from the column A/D conversion unit 4B. The digital signals are adjusted in order by the signal output unit 5 (FIG. 1) and sequentially input to the signal processing unit 2000 as digital image data of one screen.

### Signal Processing Unit

FIG. 6 is a schematic block diagram illustrating an example of a configuration of the signal processing unit 2000. Each illustrated functional element is functionally conceptual, and does not necessarily have to be physically configured as illustrated. For example, a specific form of distribution or integration of the functional blocks is not limited to the illustrated example, and all or some of the functional blocks can be functionally or physically distributed and integrated in arbitrary units according to a use situation or the like.

As described above, the digital signal based on the signal charge of the photoelectric conversion unit PDL disposed on the left side in the pixel unit 100 is input from chA, and the digital signal based on the signal charge of the photoelectric conversion unit PDR disposed on the right side in the pixel unit 100 is input from chB. The digital signals are input to both the focus detection unit 6 and the image generation unit 7.

The focus detection unit 6 includes a peak detection unit 61 and a phase difference detection unit 62. The peak detection unit 61 detects a peak position for the digital signals for one screen sequentially input from each of chA (channel A) and chB (channel B). The phase difference detection unit 62 compares the peak position detected from the digital signal input from chA with the peak position detected from the digital signal input from chB, and detects whether or not focusing is properly made and whether front-focusing or back-focusing is made. A detection result is transmitted to a control unit (not illustrated) of the imaging apparatus, and the control unit can drive a focusing mechanism based on the detection result to perform a focusing operation.

The image generation unit 7 includes an addition unit 71 and an image processing unit 72. The addition unit 71 adds the digital signals input from chA and chB. As illustrated in FIG. 5, for example, at the first read timing of the first row, the digital signal d00 corresponding to an analog addition value of two photoelectric conversion units PDL disposed on the left side in the pixel units 100 of the first column and the fifth column from the left is input from chA. Further, the digital signal d01 corresponding to an analog addition value of two photoelectric conversion units PDR disposed on the right side in the pixel units 100 of the third column and the seventh column from the left is input from chB. As is clear from pixel arrangement (Bayer arrangement) in FIG. 4, the digital signal d00 and the digital signal d01 are all based on signals read from the pixel units of the same color. Therefore, in the addition unit 71, digital signals of adjacent four pixels among the pixel units of the same color arranged in the same row are added. In other words, the addition unit 71 performs horizontal addition of four pixels of the same color.

The digital signals added by the addition unit 71 are subjected to appropriate image processing by the image processing unit 72, and are output to a recording unit (not illustrated) or a display unit (not illustrated) of the imaging apparatus as digital image signals forming one frame. The image processing unit 72 can perform, for example, noise removal processing, filtering processing, RGB processing, and the like, and may also perform other processing such as correction processing.

As described above, according to the present embodiment, it is possible to perform both image data generation by addition of four pixels of the same color and focus detection using an output signal of one frame read from the photoelectric conversion apparatus. As a result, when performing capturing of a moving image while performing distance measurement, image quality of the moving image can be improved.

In addition, according to the present embodiment, in the case of adding the analog signals, the power consumption can be suppressed by stopping driving of the A/D conversion circuit or the column amplifier of the column that is not used. In addition, since the number of pieces of data of the digital signals output from one row is reduced as compared with a case where the analog signals are not added, a time required for data processing per row in the signal output unit 5 and the signal processing unit 2000 is reduced. As a result, it is possible to lengthen a period during which the operation can be stopped (a period from time t8 to time t12 in FIG. 5) in one horizontal period, and an effect of suppressing the power consumption can be further obtained.

Furthermore, according to the present embodiment, as the connection control signal vswitch input to the column connection switching unit 9A of FIG. 3 is turned off, analog output signals from all the pixel units can be input to the A/D conversion circuit 41 of each column without analog addition. In this case, the A/D conversion circuits 41 of all the columns are driven without operating the sleep control unit 46, and data of all the columns can be sequentially selected and read by the horizontal transfer control signal hadr. The signal processing unit 2000 can perform horizontal addition of two pixels of the same color by the addition unit 71 at the same time as performing focus detection by the focus detection unit 6. That is, by switching the connection control signal vswitch from high to low, it is possible to finally switch the number of pixels to be subjected to horizontal addition by the digital signal from four to two. In other words, if the connection control signal vswitch is turned off, a higher-definition image can be acquired. As described above, according to the present embodiment, it is possible to provide a photoelectric conversion apparatus capable of performing both generation of an image having a desired characteristic and focus detection at a high speed.

### Second Embodiment

In the imaging apparatus according to the first embodiment, it is possible to select whether or not to add the analog output signals of two pixel units of the same color arranged in the horizontal direction in the photoelectric conversion apparatus, and the signal processing unit 2000 performs addition in the horizontal direction by using a digital output signal. Therefore, in image generation performed in parallel with focus detection, it has been possible to switch between horizontal addition of four pixels of the same color and horizontal addition of two pixels of the same color. The embodiment of the present technology is not limited to such an example, and may be configured to be able to switch between horizontal addition of three pixels of the same color and horizontal addition of two pixels of the same color as in the second embodiment described below, for example.

A description of matters common to the first embodiment will be simplified or omitted in a second embodiment. An overall configuration of an imaging apparatus and a configuration of a pixel unit are similar to those of the first embodiment described with reference to FIGS. 1, 2A, and 2B.

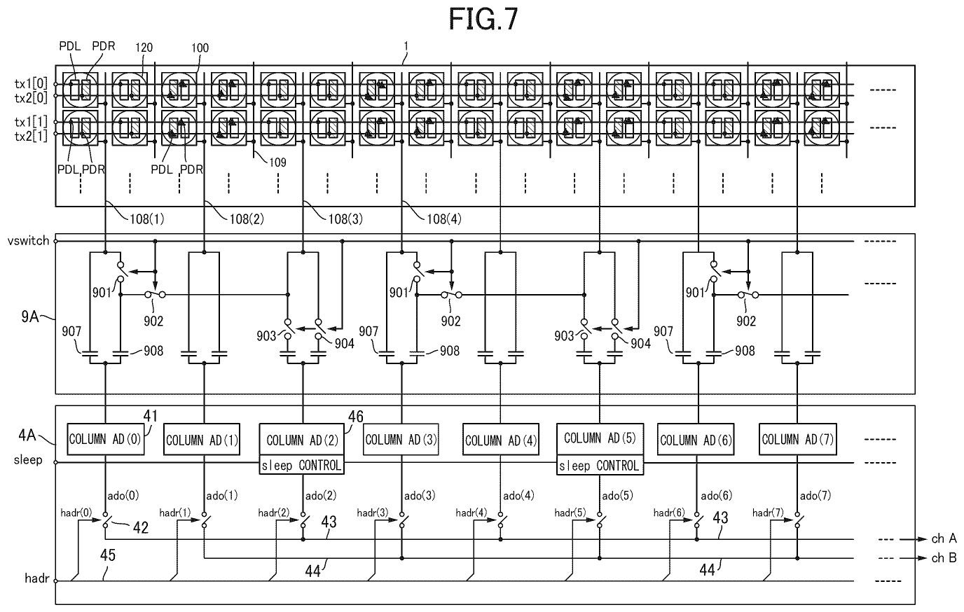

FIG. 7 is a partial circuit diagram obtained by extracting parts of a pixel section 1, a column connection switching unit 9A, and a column A/D conversion unit 4A included in a photoelectric conversion apparatus 1000 according to the second embodiment. A circuit configuration similar to that illustrated in FIG. 7 is repeatedly arranged in a portion (not illustrated) on the right side in the column connection switching unit 9A and the column A/D conversion unit 4A.

An analog signal output from a pixel unit 100 of an even-numbered column of the pixel section 1 is handled by the column connection switching unit 9B and the column A/D conversion unit 4B illustrated on the upper side of FIG. 1, and is handled in the same manner as the column connection switching unit 9A and the column A/D conversion unit 4A described below.

FIG. 7 illustrates a portion in which two pixel units 100 are arranged in the vertical direction (column direction) and 16 pixel units 100 are arranged in the horizontal direction (row direction) in the pixel section 1. Further, an enlarged part of the pixel section of FIG. 7 is similar to FIG. 4 referred to in the description of the first embodiment. FIG. 4 illustrates a portion in which two pixel units 100 are arranged in the vertical direction (column direction) and 7 pixel units 100 are arranged in the horizontal direction (row direction) in the pixel section 1.

As illustrated in FIG. 1, a vertical output line connecting the pixel units 100 of an odd-numbered column is connected to the column connection switching unit 9A, and a vertical output line connecting the pixel units 100 of the even-numbered column is connected to the column connection switching unit 9B. In FIGS. 7 and 4, a vertical output line 108 taken out to the lower side is illustrated, and, for example, the vertical output line connecting the pixel units of the first column is denoted as a vertical output line 108(1). Similarly, the vertical output lines connecting the pixel units of the third, fifth, and seventh columns are denoted as a vertical output line 108(2), a vertical output line 108(3), a and vertical output line 108(4), respectively.

In FIGS. 7 and 4, a transfer control signal tx1 and a transfer control signal tx2 supplied to the pixel units 100 of the first row are illustrated as a transfer control signal tx1[0] and a transfer control signal tx2[0], respectively. In addition, the transfer control signal tx1 and the transfer control signal tx2 supplied to the pixel units 100 of the second row are illustrated as a transfer control signal tx1[1] and a transfer control signal tx2[1].

A relationship between a photoelectric conversion unit PDL and a photoelectric conversion unit PDR disposed in each of the pixel units 100 and the transfer control signal supplied to a transfer transistor connected to the photoelectric conversion unit is as described with reference to FIG. 4 in the first embodiment.

### Column Connection Switching Unit

The column connection switching unit 9A illustrated in FIG. 7 has a function of switching a connection relationship between the vertical output line 108 connected to the pixel unit of the odd-numbered column and the A/D conversion circuit included in the column A/D conversion unit 4A. The column A/D conversion unit 4A includes column A/D (0) to column A/D (7) as A/D conversion circuits 41 corresponding to the respective columns.

As illustrated in FIG. 7, the column connection switching unit 9A includes switches 901 to 904 for switching connection of output destinations of the vertical output lines 108, and capacitors 907 and 908 capable of holding signals read from the vertical output line 108. The column connection switching unit 9A includes the capacitor 907 and the capacitor 908 connected in parallel for each column of the pixel unit, and the capacitors 907 and 908 are connected to input terminals of column A/D (0) to column A/D (7). The column connection switching unit of the present embodiment is different from the column connection switching unit of the first embodiment illustrated in FIG. 3 in a connection relationship between the switches 901 to 904 and the capacitors 907 and 908.

A connection control signal vswitch illustrated in FIG. 7 is input from a timing generation unit 3 (FIG. 1) to the column connection switching unit 9A, and opening and closing of the switches 901 to 904 are controlled by the connection control signal vswitch. FIG. 7 illustrates a case where the connection control signal vswitch is on (high). In this case, only the switch 902 is turned on, and the switch 901, the switch 903, and the switch 904 are turned off. When the connection control signal vswitch is off (low), opening and closing of each switch are reversed. Such a configuration of the switch can be implemented, for example, by using an N-type MOS transistor as the switch 902 and using P-type MOS transistors as the switch 901, the switch 903, and the switch 904. In addition, in a case where polarities of the switches 901 to 904 are all the same as each other, an inverter that outputs a signal obtained by inverting the connection control signal vswitch can be provided in each of input nodes of the switch 901, the switch 903, and the switch 904.

In each column of the column connection switching unit 9A, the capacitor 907 and the capacitor 908 are arranged in parallel. For example, in the leftmost column, the capacitor 907 is connected to the vertical output line 108(1), and the switch 901 is disposed between the capacitor 908 and the vertical output line 108(1). In addition, the switch 902 is disposed between the capacitor 908 in the leftmost column and the vertical output line 108(3). The switch 901 and the switch 902 perform an opening/closing operation exclusively by the connection control signal vswitch. Therefore, when the connection control signal vswitch is turned on, the vertical output line 108(3) is connected to the capacitor 908 in the leftmost column, and when the connection control signal vswitch is turned off, the vertical output line 108(1) is connected thereto. That is, in the leftmost column, when the connection control signal vswitch is turned on, the capacitor 907 is connected to the vertical output line 108(1), and the capacitor 908 is connected to the vertical output line 108(3). When the connection control signal vswitch is turned off, both the capacitor 907 and the capacitor 908 are connected to the vertical output line 108(1).

In the second column from the left in the column connection switching unit 9A, the capacitor 907 and the capacitor 908 are directly connected to the vertical output line 108(2). Therefore, regardless of whether the connection control signal vswitch is on or off, an analog voltage signal is input from the vertical output line 108(2) to A/D (1) of the column A/D conversion unit 4A.

In the third column from the left in the column connection switching unit 9A, the switch 903 is disposed between the capacitor 907 and the vertical output line 108(3), and the switch 904 is disposed between the capacitor 908 and the vertical output line 108(3). When the connection control signal vswitch is turned on, the switches 903 and 904 are turned off as illustrated in FIG. 7, and thus, no analog voltage signal is input from the vertical output line 108(3) to the capacitor 907 and the capacitor 908. When the connection control signal vswitch is turned off, the switch 902 is turned off, and the switch 903 and the switch 904 are turned on, and thus, an analog voltage signal is input from the vertical output line 108(3) to the capacitor 907 and the capacitor 908. A set of three columns as described above is repeatedly arranged on the right side of the fourth column from the left in the column connection switching unit 9A.

For example, a case where a signal transferred from a photoelectric conversion unit 101 (FIG. 2A) to a floating diffusion FD by the transfer control signal tx1[0] is read from the vertical output line 108 in a pixel unit group of the first row will be considered. As in the case illustrated in FIG. 7, it is assumed that the connection control signal vswitch is turned on.

In a pixel unit R(1,1) connected to the vertical output line 108(1) and a pixel unit R(1,5) connected to the vertical output line 108(3), a signal transferred from the left photoelectric conversion unit PDL is read by the transfer control signal tx1[0] (FIG. 4). Therefore, an output signal based on the left photoelectric conversion unit PDL of the pixel unit R(1,1) is held in the capacitor 907, and an output signal based on the left photoelectric conversion unit PDL of the pixel unit R(1,5) is held in the capacitor 908 in the leftmost column.

As described above, in the leftmost column in the column connection switching unit 9A, an analog signal voltages based on the signals of the left photoelectric conversion units PDL of the two pixel units of the same color are added by capacitive coupling and input to A/D (0) of the column A/D conversion unit 4A. Note that a voltage output from the capacitive coupling in parallel connection is not exactly an addition value but an average value of the output signals of the two pixel units.

At this time, in a pixel unit R(1,3) connected to the vertical output line 108(2), an analog signal based on a signal charge transferred from the right photoelectric conversion unit PDR is read by the transfer control signal tx1[0] (FIG. 4). Therefore, output signals based on the right photoelectric conversion unit PDR in the pixel unit R(1,3) are held in the capacitor 907 and the capacitor 908 in the second column from the left in the column connection switching unit 9A.

As described above, in the second column from the left in the column connection switching unit 9A, an analog signal voltage based on the signal of the right photoelectric conversion unit PDR in one pixel unit is input to A/D (1) of the column A/D conversion unit 4A. The one pixel unit has the same color as two pixel units handled in the first column from the left.

At this time, in the third column from the left in the column connection switching unit 9A, when the connection control signal vswitch is turned on, the switch 903 and the switch 904 are turned off, and thus, the capacitor 907 and the capacitor 908 are not connected to any vertical output line. Therefore, the analog signal read from the pixel unit is not input to A/D (2) of the column A/D conversion unit 4A.

As described above, when the connection control signal vswitch is on, in the first column from the left in the column connection switching unit 9A, the vertical output lines of the pixel units that read the signals transferred from the photoelectric conversion units including the color filters of the same color and disposed on the same side in the pixel units are connected via the switch 902. In other words, the analog signal voltages output from the pixel units that include the color filters of the same color and read the signals transferred from the photoelectric conversion units by using the same transfer control signal tx are added by capacitive coupling and input to the A/D conversion circuit.

When the connection control signal vswitch is on, in the third column from the left in the column connection switching unit 9A, the capacitor 907 and the capacitor 908 are not connected to the vertical output line, and the analog signal read from the pixel unit is not input to the A/D conversion circuit of the corresponding column.

On the other hand, when the connection control signal vswitch is off, in all the columns in the column connection switching unit 9A, the output signals are transmitted from the vertical output line corresponding to the column to the capacitor 907 and the capacitor 908 of the column. In other words, the output signals from the pixel units of different columns are not added, and the analog signal voltage is input to the A/D conversion circuit disposed corresponding to each column for each column of the pixel units.

### A/D Conversion Unit

Similarly to the first embodiment, also in the present embodiment, the A/D conversion unit 4A includes, corresponding to the respective columns of the column connection switching unit 9A, A/D (0), A/D (1), A/D (2), and the like serving as A/D conversion circuits that convert an analog signal into a digital signal.

In the first embodiment, the A/D conversion circuit to which the output signal of the pixel unit is not input when the connection control signal vswitch is on is, for example, A/D (2) or A/D (3), and in the present embodiment, the A/D conversion circuit to which the output signal of the pixel unit is not input when the connection control signal vswitch is on is A/D (2). Therefore, in the present embodiment, a sleep control unit 46 is provided in A/D (2) which is the A/D conversion circuit in the third column from the left. Due to a repetitive structure, the sleep control unit 46 is also provided in the A/D conversion circuit of every third column. When the connection control signal vswitch is on (that is, a stop control signal sleep is on), an operation of the A/D conversion circuit (for example, A/D (2) and A/D (5)) to which no output signal of the pixel unit is input is stopped to suppress power consumption. In a case where an amplifier (column amplifier) for amplifying the analog signal is disposed upstream of the A/D conversion circuit, when the stop control signal sleep is on, power supply to the column amplifier may be stopped to suppress the power consumption.

On the other hand, when the connection control signal vswitch is off (that is, the stop control signal sleep is off), the output signal of the pixel unit of each column is input to the A/D conversion circuit of the corresponding column, and thus, all the A/D conversion circuits are operated.

The A/D conversion unit 4A is similar to that of the first embodiment in that the A/D conversion unit 4A includes a horizontal transfer line 43, a horizontal transfer line 44, and switches 42 for sequentially transferring the digital signals output from the A/D conversion circuits.

### Signal Output Procedure

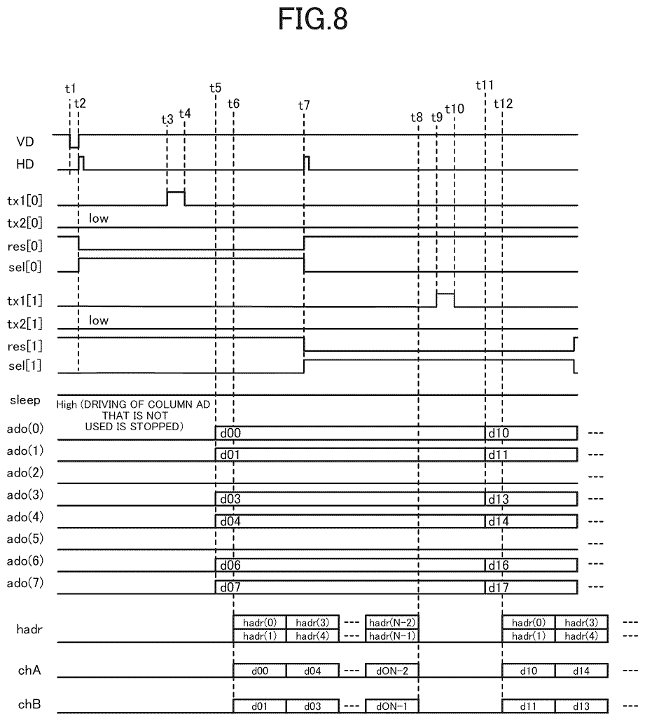

FIG. 8 is a timing chart for describing a signal output procedure in an imaging method according to the second embodiment. Similarly to FIG. 7, FIG. 8 illustrates a procedure in a case where the connection control signal vswitch is turned on, and the analog signals read from the photoelectric conversion units of the same color are added by the column connection switching unit 9A and are digitized and read by the column A/D conversion unit 4A. In FIG. 7, among the photoelectric conversion units included in each pixel unit, the photoelectric conversion unit that is not read by an operation in a time chart illustrated in FIG. 8 is indicated by hatching.

First, at time t1, a vertical synchronization signal VD becomes low, and acquisition of one frame image is started. At time t2, a horizontal synchronization signal HD is input, and a read operation in one horizontal scanning period (in this case, the read operation for the first row) is started. A reset transistor 105 of the pixel unit of the first row is turned off because a reset control signal res[0] is low, and a selection transistor 107 of the pixel unit of the first row is turned on because a selection control signal sel[0] is high.

Next, in a period from time t3 to time t4, tx1[0] becomes high, but tx2[0] remains low.[0] means a row address of the first row, and the same transfer control signal is supplied to all the pixel units of the first row.

As described for the column connection switching unit 9A, when the connection control signal vswitch is on, an addition value of the analog signals of the pixel unit R(1,1) and the pixel unit R(1,5) in which the signal charges have been transferred from the photoelectric conversion units PDL disposed on the left side is input to A/D (0). Further, an addition value of the analog signals of the pixel unit R(1,3) in which the signal charges have been transferred from the photoelectric conversion units PDR disposed on the right side is input to the adjacent A/D (1).

In addition, when the connection control signal vswitch is on, the stop control signal sleep is also on, and thus, the operation of A/D (2) is stopped by the sleep control unit 46, and the power consumption is suppressed.

Subsequently, at time t5, an A/D conversion result is fixed in the operating A/D conversion circuit, the digital signal is held, and the digital signal is output to the digital signal line. That is, a digital signal d00 is output from A/D (0) to ado (0), and a digital signal d01 is output from A/D (1) to ado (1). On the other hand, no digital signal is output from stopped A/D (2) to ado (2).

Subsequently, at time t6, the switch 42 of each column is appropriately driven by a horizontal transfer control signal hadr, and horizontal transfer is performed. First, in the first transfer period, hadr(0) and hadr(1) are simultaneously turned on, and in the next transfer period, hadr(2) is skipped, and hadr(3) and hadr(4) are simultaneously turned on. Thereafter, the horizontal transfer is sequentially performed for the first row.

In the present embodiment, as illustrated in FIG. 7, the A/D conversion circuit that outputs the digital signal obtained by adding two pixel units when the connection control signal vswitch is on is disposed for every three columns, such as A/D (0), A/D (3), or A/D (6). Therefore, the digital signal obtained by adding two pixel units is output from A/D (0) to the horizontal transfer line 43, output from A/D (3) to the horizontal transfer line 44, and output from A/D (6) to the horizontal transfer line 43.

As described above, the digital signal obtained by adding the outputs based on the left photoelectric conversion units of two pixels of the same color or the digital signal corresponding to the output based on the right photoelectric conversion units of the pixels of the same color is read from the horizontal transfer line 43 and the horizontal transfer line 44.

Next, at time t7, the next horizontal synchronization signal HD is input, and the read operation in the next one horizontal scanning period (second row) is started. In the pixel unit of the first row in which the reading is completed, the selection control signal sel[0] becomes low, and thus, the selection transistor 107 is turned off. Further, the reset control signal res[0] becomes high, and thus, the reset transistor 105 is turned on, the floating diffusion FD is connected to a power supply, and the potential is reset. At the same time, a reset transistor 105 of the pixel unit of the second row is turned off because a reset control signal res[1] becomes low, and a selection transistor 107 of the pixel unit of the second row is turned on because a selection control signal sel[1] becomes high. Thereafter, the same operation as the read operation from time t2 in the first row is performed on the second row.

At time t7, the reading of the first row to the horizontal transfer line 43 and the horizontal transfer line 44 from time t6 does not have to be completed. Since the A/D conversion circuit corresponding to each column holds the A/D conversion result of the previous row, it is possible to perform horizontal transfer of the A/D conversion result (digital signal) of the previous row in parallel with the reading of the analog signal from the pixel unit of the next row.

At time t8, the reading of the digital signal of the first row to the horizontal transfer lines 43 and 44 started from time t6 is completed. During a period from time t8 at which the horizontal transfer of the digital signal of the first row is completed to time t12 at which the horizontal transfer of the digital signal of the second row is started, operation of the horizontal transfer control signal hadr and the switch 42 may be stopped. Time t7, at which the reading of the analog signal from the pixel unit of the second row is started, and time t8, at which the reading of the digital signal of the first row is completed, may occur in reverse order from that illustrated in FIG. 8.

Next, in a period from time t9 to time t10, tx1[1] becomes high, but tx2[1] remains low.[1] means a row address of the second row, and the same signal is supplied to all the pixel units of the second row. In other words, a vertical scanning unit 2 (FIG. 1) advances row scanning in the vertical direction by one row.

At time t11, similarly to time t5 in the reading of the first row, the A/D conversion result is fixed in the operating A/D conversion circuit, the digital signal is held, and the digital signal is output to the digital signal line. That is, a digital signal d10 is output from A/D (0) to ado (0), and a digital signal d11 is output from A/D (1) to ado (1). On the other hand, no digital signal is output from stopped A/D (2) to ado (2). At time t12, similarly to time t6 in the reading of the first row, the switch 42 of each column is appropriately driven by the horizontal transfer control signal hadr, and the horizontal transfer is performed.

In this way, each time the horizontal synchronization signal HD is input, reading in units of rows is repeatedly performed while performing row scanning in the vertical direction, and the read operation of all the pixels (one frame) is completed.

As described above, the digital signal read from the photoelectric conversion apparatus 1000 illustrated in FIG. 1 is input to a signal processing unit 2000 and processed. In the photoelectric conversion apparatus 1000, the digital signals corresponding to the pixel units 100 of the odd-numbered columns are sequentially output from the column A/D conversion unit 4A, and the digital signals corresponding to the pixel units 100 of the even-numbered columns are sequentially output from the column A/D conversion unit 4B. The digital signals are adjusted in order by a signal output unit 5 and sequentially input to the signal processing unit 2000 as digital image data of one screen.

### Signal Processing Unit

Also in the present embodiment, the signal processing unit 2000 having the same configuration as that of FIG. 6 referred to in the description of the first embodiment can be used. The digital signals input from chA and chB via the signal output unit 5 are input to both the focus detection unit 6 and the image generation unit 7. In the second embodiment, in an addition unit 71 of an image generation unit 7, horizontal addition of three pixels of the same color is performed in a case where the connection control signal vswitch input to the column connection switching unit 9A is on, and horizontal addition of two pixels of the same color is performed when the connection control signal vswitch is off.

The addition unit 71 adds the digital signals input from chA and chB. As illustrated in FIG. 8, for example, at the first read timing of the first row, a digital signal d00 corresponding to an analog addition value of two photoelectric conversion units PDL disposed on the left side in the pixel units 100 of the first column and the fifth column from the left is input from chA. Further, the digital signal d01 corresponding to an analog signal value of the photoelectric conversion unit PDR disposed on the right side in the pixel unit 100 in the third column from the left is input from chB. As is clear from pixel arrangement (Bayer arrangement) in FIG. 4, the digital signal d00 and the digital signal d01 are all based on signals read from the pixel units of the same color. Therefore, in the addition unit 71, digital signals of adjacent three pixels among the pixel units of the same color arranged in the same row are added. In other words, the addition unit 71 performs horizontal addition of three pixels of the same color.

The digital signals added by the addition unit 71 are subjected to appropriate image processing by an image processing unit 72, and are output to a recording unit (not illustrated) or a display unit (not illustrated) of the imaging apparatus as digital image signals of one frame. The image processing unit 72 can perform, for example, noise removal processing, filtering processing, RGB processing, and the like, and may also perform other processing such as correction processing.

As described above, according to the present embodiment, it is possible to perform both image data generation by addition of three pixels of the same color and focus detection using an output signal of one frame read from the photoelectric conversion apparatus. As a result, when performing capturing of a moving image while performing distance measurement, image quality of the moving image can be improved.

In addition, according to the present embodiment, in the case of adding the analog signals, the power consumption can be reduced by stopping driving of the A/D conversion circuit or the column amplifier of the column that is not used. In addition, since the number of pieces of digital data output from one row is reduced as compared with a case where the analog signals are not added, a time required for data processing per row in the signal output unit 5 and the signal processing unit 2000 is reduced. As a result, it is possible to lengthen a period during which the operation can be stopped (a period from time t8 to time t12 in FIG. 8) in one horizontal period, and an effect of suppressing the power consumption can be further obtained.

Furthermore, according to the present embodiment, as the connection control signal vswitch input to the column connection switching unit 9A of FIG. 7 is turned off, analog output signals from all the pixel units can also be output to the A/D conversion circuit 41 of each column without analog addition. In this case, the A/D conversion circuits 41 of all the columns are driven without operating the sleep control unit 46, and data of all the columns can be sequentially selected and read by the horizontal transfer control signal hadr. The signal processing unit 2000 can perform horizontal addition of two pixels of the same color by the addition unit 71 at the same time as performing focus detection by a focus detection unit 6. That is, by switching the connection control signal vswitch from high to low, it is possible to finally switch the number of pixels to be subjected to horizontal addition by the digital signal from three to two. In other words, if the connection control signal vswitch is turned off, a higher-definition image can be acquired. As described above, according to the present embodiment, it is possible to provide a photoelectric conversion apparatus capable of performing both generation of an image having a desired characteristic and focus detection at a high speed.

### Third Embodiment

In the first embodiment, in order to generate an image, the digital signal based on the signal charge transferred from the photoelectric conversion unit PDL of the pixel unit and the digital signal based on the signal charge transferred from the photoelectric conversion unit PDR are digitally added in the image generation unit 7 of the signal processing unit 2000.

In a third embodiment described below, both a signal charge of a photoelectric conversion unit PDL and a signal charge of a photoelectric conversion unit PDR in a pixel unit can be transferred to a floating diffusion FD, and analog addition can be performed in the floating diffusion FD. In the description of the third embodiment, a description of matters common to the first embodiment will be simplified or omitted. An overall configuration of an imaging apparatus and a configuration of a pixel unit are similar to those of the first embodiment described with reference to FIGS. 1, 2A, and 2B. A configuration of a photoelectric conversion apparatus 1000 is also similar to that of the first embodiment described with reference to FIGS. 3 and 4. In the first embodiment, the signal output procedure described with reference to FIG. 5 is used, but in the third embodiment, a signal output procedure different from that in the first embodiment is performed.

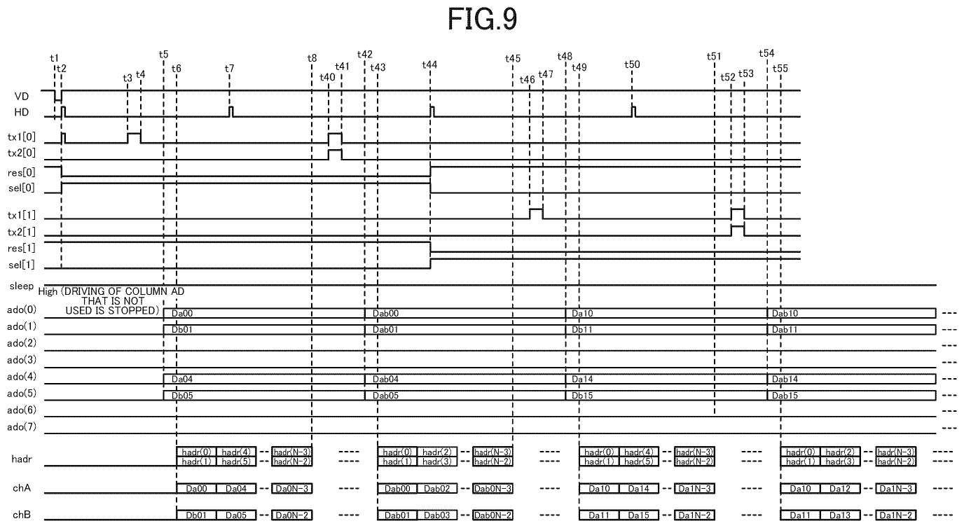

FIG. 9 is a timing chart for describing the signal output procedure in an imaging method according to the third embodiment. Since an operation up to time t4 in FIG. 9 is similar to that in FIG. 5 referred to in the description of the first embodiment, the description thereof will be omitted.

In an operation from time t3 to time t4, only one of tx1 (a transfer control signal of a first control line) and tx2 (a transfer control signal of a second control line) is turned on, which can be referred to as a first mode for convenience. On the other hand, in an operation from time t40 to time t41 described below, tx1 (the transfer control signal of the first control line) and tx2 (the transfer control signal of the second control line) are simultaneously turned on, which can be referred to as a second mode for convenience.

For example, analog signals based on the signal charges transferred from the photoelectric conversion units PDL of a pixel unit R(1,1) and a pixel unit R(1,5) by a transfer control signal tx1[0] are A/D converted by A/D conversion circuits 41 at time t5. Digital signals output to ado (0) and ado (4) serving as digital signal lines are denoted by Da00 and Da04, respectively. Furthermore, analog signals based on the signal charges transferred from the photoelectric conversion units PDR of a pixel unit R(1,3) and a pixel unit R(1,7) by the transfer control signal tx1[0] are A/D converted by the A/D conversion circuits 41 at time t5. Digital signals output to ado (1) and ado (5) serving as digital signal lines are denoted by Db01 and Db05, respectively.

Next, at time t6, horizontal scanning is performed by a horizontal transfer control signal hadr, and Da00, Da04, and the like are sequentially output to a horizontal transfer line 43 (chA), and Db01, Db05, and the like are sequentially output to a horizontal transfer line 44 (chB).

When the next horizontal synchronization signal HD is input at time t7, the processing proceeds to the next row, and reading control of the second row is started in the first embodiment (FIG. 5). However, in the present embodiment, the processing does not proceed to the second row, and reading is performed by a reading method different from that for the first row.

At time t8, reading of the first A/D conversion result started from time t6 to the horizontal transfer line 43 and the horizontal transfer line 44 is completed, and read digital data is held in a signal processing unit 2000 via chA and chB.

Next, in a period from time t40 to time t41, tx1[0] and tx2[0] become high at the same time. As a result, in each pixel unit of the first row, a transfer transistor 103 and a transfer transistor 104 illustrated in FIG. 2 are simultaneously turned on, and signal charges of a photoelectric conversion unit 101 and a photoelectric conversion unit 102 are transferred to the floating diffusion FD and added. An addition result thereof is output as an analog signal to a vertical signal line, and is A/D converted by the A/D conversion circuit 41 at the next time t42. Digital signals output to ado (0) to ado (5) serving as digital signal lines are denoted by Dab00 to Dab05.

Next, from time t43, horizontal scanning is performed by the horizontal transfer control signal hadr, Dab00, Dab02, and the like are sequentially output to chA, and Dab01, Dab03, and the like are sequentially output to chB.

As described above, the digital data read through chA and chB in the previous horizontal scanning period is held in the signal processing unit 2000, and computation processing described below is performed between the digital data and the digital data read from time t43. That is, the digital signal starting from Da00 read through chA in the previous horizontal scanning period is subtracted from the digital signal starting from Dab00 sequentially read through chA from time t43. Furthermore, the digital signal starting from Db01 read through chB in the previous horizontal scanning period is subtracted from the digital signal starting from Dab01 sequentially read through chB from time t43.

That is, in the signal processing unit 2000, calculation processing of Dab00−Da00, Dab02−Da04, and the like is sequentially performed corresponding to the digital signal having passed through chA. Similarly, computation processing of Dab01−Db01, Dab03−Db05, and the like is sequentially performed corresponding to the digital signal having passed through chB.

For example, Dab00 is a value obtained by performing analog addition of the signal charges of the photoelectric conversion unit PDL and the photoelectric conversion unit PDR in the floating diffusion FD of the pixel unit, performing analog addition of two pixel units in a column connection switching unit 9A, and performing A/D conversion. In addition, Da00 is a value obtained by performing analog addition of the analog signals corresponding to the photoelectric conversion units PDL of two pixel units in the column connection switching unit 9A and performing A/D conversion. Therefore, the digital signal corresponding to an addition value of the output signals of the photoelectric conversion units PDR of two pixel units can be acquired by the computation processing of Dab00−Da00.

Furthermore, Dab01 is a value obtained by performing analog addition of the signal charges of the photoelectric conversion unit PDL and the photoelectric conversion unit PDR in the floating diffusion FD of the pixel unit, performing analog addition of two pixel units in the column connection switching unit 9A, and performing A/D conversion. In addition, Db01 is a value obtained by performing analog addition of the analog signals corresponding to the photoelectric conversion units PDR of two pixel units in the column connection switching unit 9A and performing A/D conversion. Therefore, the digital signal corresponding to an addition value of the output signals of the photoelectric conversion units PDL of two pixel units can be acquired by the computation processing of Dab01−Db01.

Therefore, the signal processing unit 2000 can acquire digital signals corresponding to an addition value of the photoelectric conversion units PDL, an addition value of the photoelectric conversion units PDR, and an addition value of both the photoelectric conversion units PDL and PDR for two horizontal pixels of the same color.

In this manner, by executing the computation processing using the sequentially input digital signals of chA and chB for two periods of the horizontal synchronization signal HD, a digital signal obtained by adding two pixels of the same color in the horizontal direction (row direction) is acquired for each of the photoelectric conversion units PDL and PDR. A focus detection unit 6 in the signal processing unit 2000 can detect a peak of each parallax image by horizontal two-pixel addition and perform phase difference detection.

Further, from time t43, digital signals corresponding to signals subjected to analog addition in the floating diffusion FD are input to an addition unit 71 of an image generation unit 7 via chA and chB, and are subjected to digital addition. That is, first, computation of Dab00+Dab01 is performed, and then computation of Dab02+Dab03 is performed.

Dab00 is a digital signal obtained by performing analog addition of the signal charges of the PDL and the PDR in the pixel units of the first column and the third column in four adjacent pixel units among the pixel units of the same color disposed in the same row by the floating diffusion FD, reading the analog signal through the vertical output line, performing analog addition thereof by capacitive coupling by the column connection switching unit 9A, and performing A/D conversion.

Dab01 is a digital signal obtained by performing analog addition of the signal charges of the PDL and the PDR in the pixel units of the second column and the fourth column in four adjacent pixel units among the pixel units of the same color disposed in the same row by the floating diffusion FD, reading the analog signal through the vertical output line, performing analog addition thereof by capacitive coupling by the column connection switching unit 9A, and performing A/D conversion. Therefore, an addition result of four horizontal pixels of the same color is obtained by digital addition of Dab00+Dab01.

At the next time t44, an operation similar to that from time t2 is repeated, and here, row scanning in the vertical direction proceeds by one row. That is, a reset control signal res[0] in the first row becomes high, a selection control signal sel[0] becomes low, a reset control signal res[1] in the second row becomes low, and a selection control signal sel[1] becomes high. Hereinafter, since a procedure similar to that in the first row is repeated, the description after time t45 is omitted.

A stop control signal sleep is high, the A/D conversion circuit 41 that is not used is stopped, and power consumption is suppressed. In a case where a column amplifier that amplifies an analog signal is disposed upstream of the A/D conversion circuit, when the stop control signal sleep is on, power supply to the column amplifier can be stopped to suppress the power consumption.

Furthermore, in the present embodiment, a connection state of the column connection switching unit 9A is the same in the first and second read operations of the horizontal synchronization signal HD. Therefore, when correlated double sampling is performed, it is sufficient if a reset level of the floating diffusion FD is read only for the first time of the horizontal synchronization signal HD.

As described above, according to the present embodiment, it is possible to perform both image data generation by addition of four pixels of the same color and focus detection using an output signal of the same frame read from the photoelectric conversion apparatus. As a result, when performing capturing of a moving image while performing distance measurement, image quality of the moving image can be improved.

Furthermore, according to the present embodiment, in the case of adding the analog signals by using the floating diffusion FD and the column connection switching unit 9A in combination, the power consumption can be suppressed by stopping driving of the A/D conversion circuit or the column amplifier of the column that is not used. In addition, since the number of pieces of digital data output from one row is reduced as compared with a case where the analog signals are not added, a time required for data processing per row in the signal output unit 5 and the signal processing unit 2000 is reduced. As a result, it is possible to lengthen a period during which the operation can be stopped (a period from time t8 to time t42 in FIG. 9) in one horizontal period, and it is possible to further suppress the power consumption.

Furthermore, according to the present embodiment, as a connection control signal vswitch input to the column connection switching unit 9A of FIG. 3 is turned off, analog output signals from all the pixel units can be output to the A/D conversion circuit 41 of each column without analog addition by the column connection switching unit 9A. In this case, the A/D conversion circuits 41 of all the columns are driven without operating a sleep control unit 46, and data of all the columns can be sequentially selected and read by the horizontal transfer control signal hadr. The signal processing unit 2000 can perform horizontal addition of two pixels of the same color by the addition unit 71 at the same time as performing focus detection by a focus detection unit 6. That is, by switching the connection control signal vswitch from high to low, it is possible to finally switch the number of pixels to be subjected to horizontal addition by the digital signal from four to two. In other words, if the connection control signal vswitch is turned off, a higher-definition image can be acquired. As described above, according to the present embodiment, it is possible to provide a photoelectric conversion apparatus capable of performing both generation of an image having a desired characteristic and focus detection at a high speed.

### Fourth Embodiment

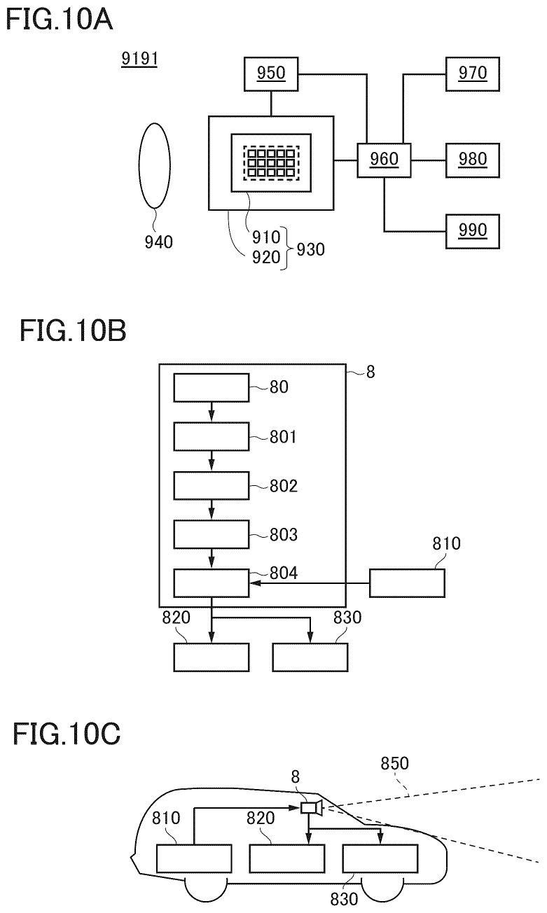

As a fourth embodiment, equipment including the imaging apparatus (semiconductor apparatus) according to any one of the above-described embodiments will be described. FIG. 10A is a schematic diagram for describing equipment 9191 including an imaging apparatus 930 (semiconductor apparatus) according to the above-described embodiment. The equipment 9191 including the imaging apparatus 930 will be described in detail.

The imaging apparatus 930 includes a semiconductor device 910 in which a first chip serving as the photoelectric conversion apparatus 1000 and a second chip serving as the signal processing unit 2000 including at least one of a memory circuit and a logic circuit are integrated. In addition to the semiconductor device 910, the imaging apparatus 930 may further include a package 920 that houses the semiconductor device 910. The package 920 can include a base to which the semiconductor device 910 is fixed and a lid such as glass that faces the semiconductor device 910. The package 920 can further include a bonding member such as a bonding wire or a bump that connects a terminal provided on the base and a terminal provided on the semiconductor device 910.

The equipment 9191 can include at least one of an optical apparatus 940, a control apparatus 950, a processing apparatus 960, a display apparatus 970, a storage apparatus 980, and a mechanical apparatus 990. The optical apparatus 940 is, for example, a lens, a shutter, or a mirror provided corresponding to the imaging apparatus 930. The control apparatus 950 controls the imaging apparatus 930. The control apparatus 950 is, for example, a semiconductor apparatus such as an application specific integrated circuit (ASIC).

The processing apparatus 960 processes a signal output from the imaging apparatus 930. The processing apparatus 960 is a semiconductor apparatus such as a central processing unit (CPU) or an ASIC for configuring a digital front end (DFE). The display apparatus 970 is an EL display apparatus or a liquid crystal display apparatus that displays information (image) obtained by the imaging apparatus 930. The storage apparatus 980 is a magnetic device or a semiconductor device that stores information (image) obtained by the imaging apparatus 930. The storage apparatus 980 is a volatile memory such as a static random-access memory (SRAM) or a dynamic random-access memory (DRAM), or a nonvolatile memory such as a flash memory or a hard disk drive.

The mechanical apparatus 990 includes a movable unit such as a motor or an engine, or a propulsion unit. In the equipment 9191, a signal output from the imaging apparatus 930 is displayed on the display apparatus 970 or is transmitted to the outside by a communication apparatus (not illustrated) included in the equipment 9191. Therefore, the equipment 9191 may further includes the storage apparatus 980 and the processing apparatus 960 separately from a storage circuit and an arithmetic circuit of the imaging apparatus 930. The mechanical apparatus 990 may be controlled based on a signal output from the imaging apparatus 930.

Furthermore, the equipment 9191 is suitable for electronic equipment such as an information terminal (for example, a smartphone or a wearable terminal) having an imaging function or a camera (for example, an interchangeable lens camera, a compact camera, a video camera, or a surveillance camera). The mechanical apparatus 990 in the camera can drive components of the optical apparatus 940 for zooming, focusing, and shutter operations. Alternatively, the mechanical apparatus 990 in the camera can move the imaging apparatus 930 for a vibration-proof operation.

Furthermore, the equipment 9191 may be transportation equipment such as a vehicle, a ship, or a flying body. The mechanical apparatus 990 in the transportation equipment can be used as a movement apparatus. The equipment 9191 serving as transportation equipment is suitable for transporting the imaging apparatus 930 and assisting and/or automating driving (steering) by the imaging function. The processing apparatus 960 for assisting and/or automating the driving (steering) can perform processing for operating the mechanical apparatus 990 serving as the movement apparatus based on information obtained by the imaging apparatus 930. Alternatively, the equipment 9191 may be medical equipment such as an endoscope, measurement equipment such as a distance measurement sensor, analytical equipment such as an electron microscope, office equipment such as a copying machine, or industrial equipment such as a robot. According to the above-described embodiment, it is possible to stably acquire an image with favorable characteristics.

Therefore, if the imaging apparatus 930 according to the present embodiment is used for the equipment 9191, the value of the equipment can also be improved. For example, it is possible to obtain excellent performance when the imaging apparatus 930 is mounted on the transportation equipment and performs imaging of the outside of the transportation equipment or measurement of an external environment. Therefore, in manufacturing and selling the transportation equipment, it is advantageous to determine to mount the semiconductor apparatus according to the present embodiment on the transportation equipment in order to enhance the performance of the transportation equipment itself. In particular, the imaging apparatus 930 is suitable for transportation equipment that performs driving assistance and/or automated driving of the transportation equipment by using information obtained by the semiconductor apparatus. Implementation in a vehicle, a ship, a flying body, and the like is not limited to application to equipment practically used for transportation purposes, and can be suitably applied to, for example, a drone or the like that performs aerial imaging for various purposes including inspection of buildings and agricultural facilities, monitoring of natural phenomena, and the like.

A photoelectric conversion system and a mobile body according to the present embodiment will be described with reference to FIGS. 10B and 10C. FIG. 10B illustrates an example of the photoelectric conversion system related to an in-vehicle camera. A photoelectric conversion system 8 includes a photoelectric conversion apparatus 80. The photoelectric conversion apparatus 80 is the photoelectric conversion apparatus 1000 serving as an electronic component included in the imaging apparatus described in the above-described embodiment. The photoelectric conversion system 8 includes an image processing unit 801 (image generation unit 7) that performs image processing on a plurality of pieces of image data acquired by the photoelectric conversion apparatus 1000, and a parallax acquisition unit 802 (phase difference detection unit 62) that calculates a parallax (a phase difference of a parallax image) from the plurality of pieces of image data acquired by the photoelectric conversion system 8. Furthermore, the photoelectric conversion system 8 includes a distance acquisition unit 803 that calculates a distance to a target object based on the calculated parallax, and a collision determination unit 804 that determines whether or not there is a possibility of collision based on the calculated distance. Here, the parallax acquisition unit 802 and the distance acquisition unit 803 are examples of a distance information acquisition unit that acquires distance information to the target object. That is, the distance information is information regarding the parallax, a defocus amount, the distance to the target object, and the like. The collision determination unit 804 may determine the possibility of collision by using any one of these pieces of distance information. The distance information acquisition unit may be implemented by dedicated hardware or may be implemented by a software module. Alternatively, the distance information acquisition unit may be implemented by a field programmable gate array (FPGA), an application specific integrated circuit (ASIC), or the like.

The photoelectric conversion system 8 is connected to a vehicle information acquisition apparatus 810, and can acquire vehicle information such as a vehicle speed, a yaw rate, and a steering angle. In addition, the photoelectric conversion system 8 is connected to a control electronic control unit (ECU) 820 which is a control apparatus that outputs a control signal for generating a braking force on the vehicle based on a determination result of the collision determination unit 804. The photoelectric conversion system 8 is also connected to a warning apparatus 830 that issues a warning to a driver based on the determination result of the collision determination unit 804. For example, in a case where the determination result of the collision determination unit 804 indicates that the possibility of collision is high, the control ECU 820 performs vehicle control to avoid collision and reduce damage by applying a brake, returning an accelerator, reducing an engine output, or the like. The warning apparatus 830 issues a warning to a user by emitting warnings such as sound, displaying warning information on a screen of a car navigation system or the like, providing vibrations to a seat belt or a steering wheel, or the like.

In the present embodiment, the photoelectric conversion system 8 images the periphery of the vehicle, for example, an area in front of or behind the vehicle. FIG. 10C illustrates the photoelectric conversion system in the case of imaging the area (imaging range 850) in front of the vehicle. The vehicle information acquisition apparatus 810 sends an instruction to the photoelectric conversion system 8 or the photoelectric conversion apparatus 80. With such a configuration, accuracy of distance measurement can be further improved.

In the above description, an example of performing control to prevent collision with another vehicle has been described, but the present technology is also applicable to control for performing automated driving following another vehicle, control for performing automated driving so as not to stray from a lane, and the like. Furthermore, the photoelectric conversion system is not limited to the vehicle such as an own vehicle, and can be applied to a mobile body (mobile apparatus) such as a ship, an aircraft, or an industrial robot, for example. In addition, the present technology can be applied not only to a mobile body but also to equipment that widely uses object recognition, such as an intelligent transport system (ITS).

With the photoelectric conversion apparatus according to the above-described embodiment, when capturing a moving image by performing horizontal pixel addition, it is possible to perform both image data generation by addition of four pixels of the same color and focus detection using an output signal of the same frame read from the photoelectric conversion apparatus. Therefore, for example, responsiveness of control of automated driving of the mobile body can be improved, which can contribute to improvement of safety and the like.

The equipment according to the present embodiment can include at least one of an optical apparatus corresponding to the imaging apparatus according to any one of the above-described embodiments, a control apparatus that controls the imaging apparatus, and a processing apparatus that processes information obtained from the imaging apparatus. Alternatively, at least one of a display apparatus that displays information obtained from the imaging apparatus, a storage apparatus that stores information obtained from the imaging apparatus, and a mechanical apparatus that operates based on information obtained from the imaging apparatus can be included.

### Modified Embodiment

Note that the present technology is not limited to the embodiments and examples described above, and many modifications can be made within the technical idea of the present technology. For example, all or some of the different embodiments described above may be combined and implemented.

In the above-described embodiment, an example in which vertical scanning is performed while row selection is performed row by row has been described, but for example, four rows of the first row, the third row, the fifth row, and the seventh row may be simultaneously selected and vertical scanning may be performed. In this case, the pixel units of the first row, the third row, the fifth row, and the seventh row are connected to one vertical output line, and the analog signals can be added by the vertical output line in a pseudo manner. By doing so, an operation of addition of four pixels in the vertical direction and the horizontal direction can be implemented.

Furthermore, the addition in the floating diffusion FD exemplified in the third embodiment can also be applied to the configuration of the second embodiment in which horizontal addition of three pixels is possible.

The application of the imaging apparatus described in each embodiment is not limited to imaging. For example, the present technology is also applicable to a distance measurement apparatus (an apparatus for distance measurement using focus detection, time of flight (TOF), or the like), a photometric apparatus (an apparatus for measuring an incident light quantity or the like), or the like.

The photoelectric conversion apparatus to which the present technology can be applied is not limited to a specific form, and may be, for example, any one of a front-illuminated type sensor and a back-illuminated type sensor. Alternatively, the photoelectric conversion apparatus may be a stacked-type photoelectric conversion apparatus in which a semiconductor chip including a light receiving unit and a semiconductor chip including an electric circuit such as a logic circuit are stacked.

The present technology can also be implemented by processing in which a program for implementing one or more functions of the embodiments is supplied to a system or a device via a network or a storage medium, and one or more processors in a computer of the system or the device read and execute the program. The present technology can also be implemented by a circuit (for example, an ASIC) that implements one or more functions.

According to one aspect disclosed in the present specification and the drawings, it is possible to provide a photoelectric conversion apparatus capable of performing both generation of an image having a desired characteristic and focus detection at a high speed. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-113699, filed Jul. 16, 2024, which is hereby incorporated by reference herein in its entirety.

What is claimed is:

1. A photoelectric conversion apparatus comprising:
a pixel section in which a plurality of pixels is arranged along rows and columns, each of the plurality of pixels including a first photoelectric conversion unit, a second photoelectric conversion unit, a first transfer transistor, a second transfer transistor, a floating diffusion, and one microlens shared by the first photoelectric conversion unit and the second photoelectric conversion unit;
an output line group including a plurality of output lines, each of the plurality of output lines transmitting an analog signal output from a corresponding one of the plurality of pixels arranged along the columns;
an A/D conversion unit including a first A/D conversion circuit, a second A/D conversion circuit, and a third A/D conversion circuit; and
a switching unit configured to switch to which A/D conversion circuit included in the A/D conversion unit the analog signal transmitted by each of the plurality of output lines is to be input, wherein
in each of the plurality of pixels, the second photoelectric conversion unit is disposed in the same direction with respect to the first photoelectric conversion unit, the first transfer transistor is included in a transfer path of a signal charge from the first photoelectric conversion unit to the floating diffusion, and the second transfer transistor is included in a transfer path of a signal charge from the second photoelectric conversion unit to the floating diffusion,
one row of the pixel section includes a first pixel, a second pixel, and a third pixel,
a first control line is connected to a gate of the first transfer transistor of the first pixel, a gate of the second transfer transistor of the second pixel, and a gate of the first transfer transistor of the third pixel,
a second control line is connected to a gate of the second transfer transistor of the first pixel, a gate of the first transfer transistor of the second pixel, and a gate of the second transfer transistor of the third pixel,
a first output line included in the output line group is connected to the first pixel,
a second output line included in the output line group is connected to the second pixel,
a third output line included in the output line group is connected to the third pixel,
the switching unit is configured to
input the analog signal transmitted through the first output line to the first A/D conversion circuit,
input the analog signal transmitted through the second output line to the second A/D conversion circuit, and
switch whether to input the analog signal transmitted by the third output line together with the analog signal transmitted by the first output line to the first A/D conversion circuit or to input the analog signal transmitted by the third output line to the third A/D conversion circuit, and
power consumption of the third A/D conversion circuit is lower than both power consumption of the first A/D conversion circuit and power consumption of the second A/D conversion circuit in a period in which the switching unit inputs the analog signal transmitted through the third output line together with the analog signal transmitted by the first output line to the first A/D conversion circuit.

2. The photoelectric conversion apparatus according to claim 1, wherein
the third A/D conversion circuit is configured to stop operating in the period in which the switching unit inputs the analog signal transmitted through the third output line together with the analog signal transmitted by the first output line to the first A/D conversion circuit.

3. The photoelectric conversion apparatus according to claim 1, wherein
each of the first A/D conversion circuit, the second A/D conversion circuit, and the third A/D conversion circuit includes an amplifier that amplifies the analog signal transmitted by the output line, and
power supply to the amplifier included in the third A/D conversion circuit is stopped in the period in which the switching unit inputs the analog signal transmitted through the third output line together with the analog signal transmitted by the first output line to the first A/D conversion circuit.

4. The photoelectric conversion apparatus according to claim 1, wherein
the first pixel, the second pixel, and the third pixel include color filters of the same color.

5. The photoelectric conversion apparatus according to claim 1, wherein
the one row of the pixel section further includes a fourth pixel,
the A/D conversion unit further includes a fourth A/D conversion circuit,
the output line group includes a fourth output line that transmits the analog signal output from the fourth pixel,
the first control line is connected to the second transfer transistor of the fourth pixel,
the second control line is connected to the first transfer transistor of the fourth pixel,
the switching unit is configured to switch whether to input the analog signal transmitted through the fourth output line together with the analog signal transmitted by the second output line to the second A/D conversion circuit or to input the analog signal transmitted by the fourth output line to the fourth A/D conversion circuit, and
power consumption of the fourth A/D conversion circuit is lower than both the power consumption of the first A/D conversion circuit and the power consumption of the second A/D conversion circuit in a period in which the switching unit inputs the analog signal transmitted through the fourth output line together with the analog signal transmitted by the second output line to the second A/D conversion circuit.

6. The photoelectric conversion apparatus according to claim 5, wherein
the fourth A/D conversion circuit is configured to stop operating in the period in which the switching unit inputs the analog signal transmitted through the fourth output line together with the analog signal transmitted by the second output line to the second A/D conversion circuit.

7. The photoelectric conversion apparatus according to claim 5, wherein
the switching unit is configured to input the analog signal transmitted through the fourth output line together with the analog signal transmitted by the second output line to the second A/D conversion circuit in a period in which the analog signal transmitted through the third output line together with the analog signal transmitted by the first output line is input to the first A/D conversion circuit.

8. The photoelectric conversion apparatus according to claim 5, wherein
in a case where the switching unit inputs the analog signal transmitted through the third output line together with the analog signal transmitted by the first output line to the first A/D conversion circuit,
the first A/D conversion circuit performs A/D conversion on a signal obtained by averaging the analog signal of the first output line and the analog signal of the third output line and outputs a first digital signal,
the second A/D conversion circuit performs A/D conversion on a signal obtained by averaging the analog signal of the second output line and the analog signal of the fourth output line and outputs a second digital signal, and
the third A/D conversion circuit does not output a digital signal.

9. The photoelectric conversion apparatus according to claim 1, wherein
the one row of the pixel section further includes a fourth pixel,
the A/D conversion unit further includes a fourth A/D conversion circuit,
the output line group includes a fourth output line that transmits the analog signal output from the fourth pixel,
the first control line is connected to the second transfer transistor of the fourth pixel,
the second control line is connected to the first transfer transistor of the fourth pixel,
the switching unit is configured to input the analog signal transmitted through the fourth output line to the fourth A/D conversion circuit, and
the power consumption of the third A/D conversion circuit is lower than power consumption of the fourth A/D conversion circuit in the period in which the switching unit inputs the analog signal transmitted through the third output line together with the analog signal transmitted by the first output line to the first A/D conversion circuit.

10. The photoelectric conversion apparatus according to claim 5, wherein
the first pixel, the second pixel, the third pixel, and the fourth pixel include color filters of the same color.

11. The photoelectric conversion apparatus according to claim 1, wherein
in a case where the switching unit inputs the analog signal transmitted through the third output line together with the analog signal transmitted by the first output line to the first A/D conversion circuit,
the first A/D conversion circuit performs A/D conversion on a signal obtained by averaging the analog signal of the first output line and the analog signal of the third output line and outputs a first digital signal,
the second A/D conversion circuit performs A/D conversion on the analog signal of the second output line and outputs a second digital signal, and
the third A/D conversion circuit does not output a digital signal.

12. The photoelectric conversion apparatus according to claim 1, wherein
in a case where the switching unit connects the analog signal transmitted through the third output line to the third A/D conversion circuit,
the first A/D conversion circuit performs A/D conversion on the analog signal of the first output line and outputs a first digital signal,
the second A/D conversion circuit performs A/D conversion on the analog signal of the second output line and outputs a second digital signal, and
the third A/D conversion circuit performs A/D conversion on the analog signal of the third output line and outputs a third digital signal.

13. The photoelectric conversion apparatus according to claim 1, wherein
a first mode and a second mode are switchable,
in the first mode, only one of a transfer control signal of the first control line and a transfer control signal of the second control line is turned on, and
in the second mode, the transfer control signal of the first control line and the transfer control signal of the second control line are simultaneously turned on.

14. The photoelectric conversion apparatus according to claim 13, wherein
the switching unit is configured to sequentially execute the first mode and the second mode in a state of inputting the analog signal transmitted through the third output line together with the analog signal transmitted by the first output line to the first A/D conversion circuit.

15. The photoelectric conversion apparatus according to claim 13, wherein
the switching unit is configured to sequentially execute the first mode and the second mode in a state of inputting the analog signal transmitted through the third output line to the third A/D conversion circuit.

16. The photoelectric conversion apparatus according to claim 1, wherein
in a state in which the switching unit inputs the analog signal transmitted through the third output line together with the analog signal transmitted by the first output line to the first A/D conversion circuit,
in each of the plurality of pixels, the floating diffusion is connected to a power supply and reset, and
the signal charge is transferred from at least one of the first photoelectric conversion unit and the second photoelectric conversion unit to the floating diffusion.

17. The photoelectric conversion apparatus according to claim 1, wherein
in a state in which the switching unit inputs the analog signal transmitted through the third output line to the third A/D conversion circuit,
in each pixel of the pixel section, the floating diffusion is connected to a power supply and reset, and
the signal charge is transferred from at least one of the first photoelectric conversion unit and the second photoelectric conversion unit to the floating diffusion.

18. The photoelectric conversion apparatus according to claim 5, further comprising a channel A and a channel B, wherein
a digital signal output from the first A/D conversion circuit and a digital signal output from the third A/D conversion circuit are output from the channel A, and
a digital signal output from the second A/D conversion circuit and a digital signal output from the fourth A/D conversion circuit are output from the channel B.

19. An imaging apparatus comprising:
the photoelectric conversion apparatus according to claim 18; and
a signal processing unit configured to perform signal processing by using the digital signal output from the channel A and the digital signal output from the channel B.

20. Equipment comprising:
the photoelectric conversion apparatus according to claim 1; and
at least one of six apparatuses including
an optical apparatus corresponding to the photoelectric conversion apparatus,
a control apparatus configured to control the photoelectric conversion apparatus,
a processing apparatus configured to process information obtained from the photoelectric conversion apparatus,
a display apparatus configured to display information obtained from the photoelectric conversion apparatus,
a storage apparatus configured to store information obtained from the photoelectric conversion apparatus, and
a mechanical apparatus configured to operate based on information obtained from the photoelectric conversion apparatus.
